(19) United States
(12) Patent Application Publication
(10) Pub. No.: US 2024/0385121 A1
(43) Pub. Date: Nov. 21, 2024

(54) SYSTEM, METHOD, AND COMPUTER DEVICE FOR AUTOMATED VISUAL INSPECTION USING ADAPTIVE REGION OF INTEREST SEGMENTATION

(71) Applicant: MUSASHI AI NORTH AMERICA INC., Waterloo (CA)

(72) Inventor: Saeed Bakhshmand, Waterloo (CA)

(21) Appl. No.: 18/552,591

(22) PCT Filed: Mar. 1, 2022
(86) PCT No.: PCT/CA2022/050289

§ 371 Date: Sep. 26, 2023

Related U.S. Application Data
(60) Provisional application No. 63/167,386, filed on Mar. 29, 2021.

(51) Int. Cl. G01N 21/88; G06T 7/00; G06T 7/11; G06V 10/764

(52) U.S. Cl. CPC G01N 21/8851; G06T 7/0008; G06T 7/001; G06T 7/11; G01N 2021/8883; G01N 2021/8887; G06T 2207/20004; G06T 2207/20081; G06T 2207/20084; G06T 2207/20104; G06T 2207/30108; G06V 10/764

(57) ABSTRACT

Computer systems, methods, and devices for visual inspection using adaptive ROI segmentation are provided. The system includes a camera for acquiring an inspection image of the target article and an AI visual inspection computing device for detecting defects or anomalies in the target article. The device includes a communication interface for receiving the inspection image acquired by the camera, an adaptive ROI segmentation module for processing the inspection image using an ROI segmentation model to generate a masked inspection image in which regions not of interest are masked, an image analysis module for receiving the masked inspection image and analyzing the masked inspection image using an image analysis model to generate output data indicating presence of the defects or anomalies detected by the image analysis model, wherein analysis of the masked inspection image is limited to non-masked regions of interest (“ROIs”), and an output interface for displaying the output data.

### TECHNICAL FIELD

The following relates generally to machine learning-based visual inspection, and more particularly to visual inspection using adaptive region of interest (“ROI”) segmentation.

### INTRODUCTION

Image analysis, object detection, and like procedures often require significant computational resources in order to thoroughly analyze each part of an input image. Such significant computational resources can be prohibitive both as a function of cost and time when not all of an input image has the potential to be useful or reveal valuable information.

Similarly, as object detection and analysis evolves, false positives may arise where regions of an input image and/or the background thereof may contain features or elements similar but not identical to desired objects, features, etc. Where these distinctions are not evident to the computer systems and devices that perform such object detection and analysis, further computational resources are wasted on not only detecting such false positives but also potentially to downstream operations triggered by the detection of a false positive. This can be particularly problematic in visual inspection operations where the time for inspecting an object is limited, such as in manufacturing quality control applications or the like.

Accordingly, there is a demonstrated need for a system, method, and device capable of masking or blocking areas of an input image that are not of interest with respect to the computer task being performed.

### SUMMARY

A system for visual inspection of a target article using adaptive region of interest (“ROI”) segmentation is provided. The system includes a camera and an AI visual inspection computing device for detecting defects or anomalies in the target article. The camera acquires an inspection image of the target article. The AI visual inspection computing device includes a communication interface for receiving the inspection image acquired by the camera, an adaptive ROI segmentation module for processing the inspection image using an ROI segmentation model to generate a masked inspection image in which regions not of interest (“nROIs”) are masked, an image analysis module for receiving the masked inspection image and analyzing the masked inspection image using an image analysis model to generate output data indicating presence of the defects or anomalies detected by the image analysis model, wherein analysis of the masked inspection image is limited to non-masked ROIs. The AI visual inspection computing device also includes an output interface for displaying the output data.

The image analysis model may include an object detection model trained to detect at least one defect class in the masked inspection image.

The image analysis model may include a golden sample analysis module configured to compare the masked inspection image to a golden sample image of the target article.

The image analysis model may include an object detection model and a golden sample analysis module.

The system may include a comparison module for comparing object detection output data generated by the object detection model with golden sample output data generated by the golden sample analysis module.

The golden sample module may include a generative model for generating the golden sample image from the inspection image.

The output data may include a defect type and a defect location for each defect detected by the object detection model.

The adaptive ROI segmentation model may be trained to identify and mask a non-uniform area of the inspection image.

The non-uniform area may include any one or more of an improperly illuminated area in the inspection image, a user-defined non-uniform area, a component of the target article that varies across different target articles of the same class, and an irregularly textured area of the target article.

The output data may classify the target article as either defective or non-defective.

A method of visual inspection of a target article using adaptive region of interest (“ROI”) segmentation is provided. The method includes acquiring an inspection image of a target article, processing the inspection image by masking nROIs in the inspection image using an adaptive ROI segmentation model, analyzing the masked inspection image using an image analysis model to detect defects or anomalies in the target article, generating output data based on an output of the image analysis model, the output data indicating presence of the detected defects or anomalies, and displaying the output data at a user device.

The method may include comparing object detection output data generated by an object detection model with golden sample output data generated by a golden sample analysis module.

The output data may include a defect type and a defect location for each defect detected by the object detection model.

The adaptive ROI segmentation model may be trained to identify and mask a non-uniform area of the inspection image.

The non-uniform area may include any one or more of an improperly illuminated area in the inspection image, a user-defined non-uniform area, a component of the target article that varies across different target articles of the same class, and an irregularly textured area of the target article.

An AI visual inspection computing device for detecting objects in an inspection image using adaptive region of interest (“ROI”) segmentation is provided. The device includes a communication interface for receiving the inspection image acquired by a camera, an adaptive ROI segmentation module for processing the inspection image using an ROI segmentation model to generate a masked inspection image in which regions not of interest (“nROIs”) are masked, an image analysis module for receiving the masked inspection image and analyzing the masked inspection image using an image analysis model to generate output data indicating presence of the objects detected by the image analysis model, wherein analysis of the masked inspection image is limited to non-masked regions of interest (“ROIs”), and an output interface for displaying the output data.

The device may include a comparison module for comparing object detection output data generated by an object detection model with golden sample output data generated by a golden sample analysis module.

The output data may include a defect type and a defect location for each defect detected by the object detection model.

The adaptive ROI segmentation model may be trained to identify and mask a non-uniform area of the inspection image.

The non-uniform area may include any one or more of an improperly illuminated area in the inspection image, a user-defined non-uniform area, a component of the target article that varies across different target articles of the same class, and an irregularly textured area of the target article.

Other aspects and features will become apparent, to those ordinarily skilled in the art, upon review of the following description of some exemplary embodiments.

### BRIEF DESCRIPTION OF THE DRAWINGS

The drawings included herewith are for illustrating various examples of articles, methods, and apparatuses of the present specification. In the drawings:

FIG. 1 is a schematic diagram of a computer system for adaptive ROI segmentation, according to an embodiment;

FIG. 2 is a block diagram of a computing device of the present disclosure, according to an embodiment;

FIG. 3 is a block diagram of a visual inspection system including adaptive ROI segmentation, according to an embodiment;

FIG. 4 is a block diagram of a computer system for visual inspection using adaptive ROI segmentation, according to an embodiment;

FIG. 5A is a block diagram of a defect detection pipeline of a visual inspection system including adaptive ROI segmentation, according to an embodiment;

FIG. 5B is a block diagram of a training pipeline for training an adaptive ROI segmentation module for use in the defect detection pipeline of FIG. 5A, according to an embodiment;

FIG. 6 is a diagram showing illustrations of input and output images and a schematic representation of an adaptive ROI segmenter for receiving the input images and generating the output images, according to an embodiment;

FIG. 7 shows illustrations of a plurality of image pairs each comprising an input image and output image of a camshaft provided to and generated by, respectively, a system for ROI segmentation, according to an embodiment;

FIG. 8 is a block diagram of a visual inspection processing pipeline for golden sample image analysis using adaptive ROI segmentation, according to an embodiment;

FIG. 9 is a flow diagram of a method of visual inspection using adaptive ROI segmentation in the context of golden sample image analysis, according to an embodiment;

FIG. 10 is a block diagram of a visual inspection pipeline for golden sample image analysis using adaptive ROI segmentation, according to an embodiment;

FIG. 11 is a flow diagram of a method of visual inspection using adaptive ROI segmentation in the context of golden image analysis, according to an embodiment;

FIG. 12 is a block diagram of a visual inspection processing pipeline for golden sample image analysis using adaptive ROI segmentation, according to an embodiment;

FIG. 13 is a flow diagram of a method of visual inspection using adaptive ROI segmentation in the context of golden sample image analysis, according to an embodiment;

FIG. 14 is a block diagram of a visual inspection processing pipeline for object detection image analysis using adaptive ROI segmentation, according to an embodiment;

FIG. 15 is a block diagram of the object detection model of FIG. 14, according to an embodiment; and

FIG. 16 is a flow diagram of a method of visual inspection using adaptive ROI segmentation in the context of object detection image analysis, according to an embodiment.

### DETAILED DESCRIPTION

Various apparatuses or processes will be described below to provide an example of each claimed embodiment. No embodiment described below limits any claimed embodiment and any claimed embodiment may cover processes or apparatuses that differ from those described below. The claimed embodiments are not limited to apparatuses or processes having all of the features of any one apparatus or process described below or to features common to multiple or all of the apparatuses described below.

One or more systems described herein may be implemented in computer programs executing on programmable computers, each comprising at least one processor, a data storage system (including volatile and non-volatile memory and/or storage elements), at least one input device, and at least one output device. For example, and without limitation, the programmable computer may be a programmable logic unit, a mainframe computer, server, and personal computer, cloud-based program or system, laptop, personal data assistance, cellular telephone, smartphone, or tablet device.

Each program is preferably implemented in a high-level procedural or object-oriented programming and/or scripting language to communicate with a computer system. However, the programs can be implemented in assembly or machine language, if desired. In any case, the language may be a compiled or interpreted language. Each such computer program is preferably stored on a storage media or a device readable by a general or special purpose programmable computer for configuring and operating the computer when the storage media or device is read by the computer to perform the procedures described herein.

A description of an embodiment with several components in communication with each other does not imply that all such components are required. On the contrary, a variety of optional components are described to illustrate the wide variety of possible embodiments of the present invention.

Further, although process steps, method steps, algorithms or the like may be described (in the disclosure and/or in the claims) in a sequential order, such processes, methods and algorithms may be configured to work in alternate orders. In other words, any sequence or order of steps that may be described does not necessarily indicate a requirement that the steps be performed in that order. The steps of processes described herein may be performed in any order that is practical. Further, some steps may be performed simultaneously.

When a single device or article is described herein, it will be readily apparent that more than one device/article (whether or not they cooperate) may be used in place of a single device/article. Similarly, where more than one device or article is described herein (whether or not they cooperate), it will be readily apparent that a single device/article may be used in place of the more than one device or article.

The following relates generally to machine learning-based visual inspection, and more particularly to systems, methods, and devices for visual inspection using adaptive region of interest (“ROI”) segmentation. The system uses ROI segmentation to identify regions of interest (“ROIs”) in an inspection image and mask or block regions that are not of interest (“non-ROIs”, “nROIs”). The ROIs of the inspection image are analyzed using an image analysis module including a machine learning model to detect defects in the inspection image (i.e. in the ROIs). In limiting the analysis to the ROIs determined by the ROI segmentation process, the system may advantageously minimize false positives and use computational resources more efficiently.

The present disclosure also provides systems, methods, and devices for reducing visual inspection cycle time for an automated visual inspection process through the user of adaptive ROI segmentation.

The system of the present disclosure may advantageously limit processed areas of an image being analyzed to pre-decided optimal areas. Chances of false positives can be reduced. Different tolerances or operations can be assigned for individual regions through image processing methods such as connected component analysis and region labelling. The system may assist in blocking the background in object detection applications (thereby lowering chance of false positives). The system may offer flexible definition of geometrical regions (with object detection, regions have to be rectangular) For an area that has an irregular shape (e.g., ellipsoid), pixels outside of the ROI and inside the rectangle may be ignored. For example, in cases where an object under visual inspection is gripped by a robot gripper, the robot gripper may appear in the image. Parts of the robot gripper may have the potential to be detected and interpreted as defects when analyzing the image (false positive). The system may reduce such false positives by covering the robot gripper or part thereof that may produce the false positive.

In an industrial and/or commercial setting, a variety of parts may need to be analyzed for mechanical fitness before delivery to or use by a customer. Similarly, each of the variety of parts may be subject to many different classes of defects or abnormalities. Such defects may render a part defective such that a manufacturer thereof may not be able to sell the part while retaining customer loyalty and/or complying with applicable laws and/or regulation. Such abnormalities may not render a part so defective. Nevertheless, it may be advantageous to the manufacturer to be aware of what defects and/or abnormalities are arising on which parts. Such knowledge may allow a manufacturer to trace problems to particular machines, processes, supplies, or precursors. Such knowledge may further allow a manufacturer to correct and prevent the defects or abnormalities revealed under analysis.

Detailed analysis of each of the variety of parts may be costly as a function of time. Human workers are generally not as capable as a computer or machine of performing a detail-intensive, rote task for long periods of time without concomitant losses in detail in the short term and job satisfaction in the long term. Accordingly, it is highly advantageous to the manufacturer to use a system for automated visual inspection to analyze the parts and detect the defects and/or abnormalities.

However, automated visual inspection analysis, particularly using computer vision applications, may be computationally intensive and require a significant amount of a computer's time and/or computational capacity. Additionally, computational resources may be wasted by analyzing regions of an image that are not of interest and/or that may produce false positives. The added processing time of analyzing regions of the image that are not of interest can significantly increase cycle time (i.e., the time to completely inspect a part) while adding little or no value to the task. Detection of false positives in the visual inspection context can have significant negative downstream effects, such as by classifying a part as defective when it is not.

Accordingly, the determination of ROIs and nROIs in an inspection image through segmentation of the input image to mask or otherwise block regions not of interest may advantageously improve the efficiency of the image analysis and accordingly improve the visual inspection process. The present disclosure refers to such segmentation of the input image to mask regions not of interest as ROI segmentation.

For example, where a certain mechanical part needs to be inspected for proper assembly of part components or the presence of defects in the part and an input image of that mechanical part is provided to an object detection model, neural network, artificial intelligence platform, or other computer device or system, the present disclosure may mask or block areas of the input image that are not relevant to the inspection of the mechanical part.

As a further advantage, adaptive ROI segmentation may limit processed areas to predetermined optimal areas. Different tolerances or operations may be assigned for individual regions.

As a still further advantage, adaptive ROI segmentation may enable region-tracking capability over multiples frames or images.

As a still further advantage, adaptive ROI segmentation may offer flexible definition of geometrical regions on an image.

While the present disclosure describes systems and methods for ROI segmentation for defect detection and visual inspection of objects, the systems, methods, and devices provided herein may have further applications and different uses beyond those described herein, whether in the context of defect detection and visual inspection of objects or otherwise. Computational devices herein described as configured for object detection may have functions other than object detection. Input data may vary in those cases, as may output data, but elements of the present disclosure, such the masking of regions not of interest, may operate similarly.

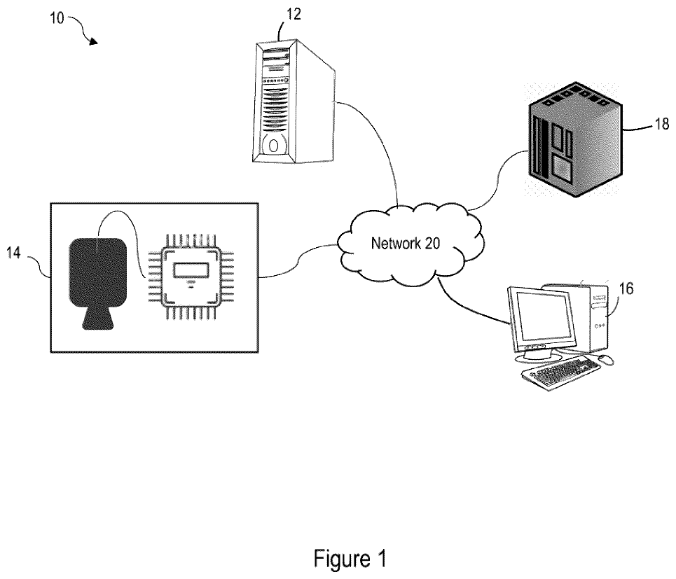

Referring now to FIG. 1, shown therein is a computer system 10 for visual inspection using adaptive ROI segmentation, in accordance with an embodiment. The system 10 includes an adaptive ROI segmentation device 12, which communicates with a camera device 14, a second model device 16, and an integration device 18 via a network 20.

The adaptive ROI segmentation device 12 is configured to perform adaptive ROI segmentation. The adaptive ROI segmentation device 12 may include multiple masking models. Each masking model may be trained to perform a certain masking task according to previous user labelling of certain regions of previous input images as not of interest (nROIs). Such user labelling may include the user masking nROIs. Masking may include detecting optimal brightness within the input image, such as the brightness of a certain object within the input image presented to the adaptive ROI segmentation device 12. Each masking model may include deep learning techniques, such as neural networks (e.g., convolutional neural networks or CNNs), and machine-learning approaches. In machine-learning ROI segmentation approaches, relevant features of the sought object(s) are defined in advance, while such definition is not required in neural networks. In classic computer vision approaches, rule-based segmentation is used to allow the adaptive ROI segmentation device 12 to perform its tasks using pixel contrast or colour information to draw the borders. In deep-learning models, an algorithm is trained to draw a boundary using holistic image appearance.

The adaptive ROI segmentation device 12 may also be configured to perform tasks outside the context of ROI segmentation. Such tasks may include other forms of machine learning (“ML”) or artificial intelligence tasks or non-ML tasks.

The devices 12, 14, 16, 18 may be a server computer, node computing device (e.g., JETSON computing device or the like), embedded device, desktop computer, notebook computer, tablet, PDA, smartphone, or another computing device. The devices 12, 14, 16, 18 may include a connection with the network 20 such as a wired or wireless connection to the Internet. In some cases, the network 20 may include other types of computer or telecommunication networks. The devices 12, 14, 16, 18 may include one or more of a memory, a secondary storage device, a processor, an input device, a display device, and an output device. Memory may include random access memory (RAM) or similar types of memory. Also, memory may store one or more applications for execution by processor. Applications may correspond with software modules comprising computer executable instructions to perform processing for the functions described below. Secondary storage device may include a hard disk drive, floppy disk drive, CD drive, DVD drive, Blu-ray drive, or other types of non-volatile data storage. The processor may execute applications, computer readable instructions or programs. The applications, computer readable instructions or programs may be stored in memory or in secondary storage or may be received from the Internet or other network 20.

Input device may include any device for entering information into devices 12, 14, 16, 18. For example, input device may be a keyboard, keypad, cursor-control device, touchscreen, camera, or microphone. Display device may include any type of device for presenting visual information. For example, display device may be a computer monitor, a flat-screen display, a projector, or a display panel. Output device may include any type of device for presenting a hard copy of information, such as a printer for example. Output device may also include other types of output devices such as speakers, for example. In some cases, device 12, 14, 16, 18 may include multiple of any one or more of processors, applications, software modules, second storage devices, network connections, input devices, output devices, and display devices.

Although devices 12, 14, 16, 18 are described with various components, one skilled in the art will appreciate that the devices 12, 14, 16, 18 may in some cases contain fewer, additional or different components. In addition, although aspects of an implementation of the devices 12, 14, 16, 18 may be described as being stored in memory, one skilled in the art will appreciate that these aspects can also be stored on or read from other types of computer program products or computer-readable media, such as secondary storage devices, including hard disks, floppy disks, CDs, or DVDs; a carrier wave from the Internet or other network; or other forms of RAM or ROM. The computer-readable media may include instructions for controlling the devices 12, 14, 16, 18 and/or processor to perform a particular method.

Devices 12, 14, 16, 18 can be described performing certain acts. It will be appreciated that any one or more of these devices may perform an act automatically or in response to an interaction by a user of that device. That is, the user of the device may manipulate one or more input devices (e.g., a touchscreen, a mouse, or a button) causing the device to perform the described act. In many cases, this aspect may not be described below, but it will be understood.

As an example, it is described below that the devices 12, 14, 16, 18 may send information to one or more other device 12, 14, 16, 18. Generally, the device may receive a user interface from the network 20 (e.g., in the form of a webpage). Alternatively, or in addition, a user interface may be stored locally at a device (e.g., a cache of a webpage or a mobile application).

A user interface component of the adaptive ROI segmentation device 12 may also include one or more user interface elements for receiving input from the user. For example, the user interface component may provide a yes/no or similar binary option for receiving user input data indicating whether a region within the input image is a region of interest. In a particular case, the user interface may present and highlight a particular region delimited by the adaptive ROI segmentation device 12 in the input image so that the user may determine whether the region is a region of interest. In other cases, the user may define nROIs by providing input data to the ROI segmentation device 12 via the user interface.

As a further example, upon the user interface component of the adaptive ROI segmentation device 12 receiving certain input data (e.g., an answer “no” to a question of whether a given region is a region of interest, such as by clicking on a user interface element labelled “no”), the adaptive ROI segmentation device 12 may be configured to incorporate that new data during training. The data so incorporated can be logged as a training sample for a future training dataset that can be used to further train the adaptive ROI segmentation device 12. For example, input data provided via the user interface may be used by and cause the adaptive ROI segmentation device 12 to tag or otherwise indicate (such as by associating metadata) that a particular input image generated by the system 10 is a training sample for a particular ROI or nROI.

The devices 12, 14, 16, 18 may be configured to receive a plurality of information, from one or more of the plurality of devices 12, 14, 16, 18.

In response to receiving information, the respective device 12, 14, 16, 18 may store the information in storage database. The storage may correspond with secondary storage of one or more other devices 12, 14, 16, 18. Generally, the storage database may be any suitable storage device such as a hard disk drive, a solid-state drive, a memory card, or a disk (e.g., CD, DVD, or Blu-ray etc.). Also, the storage database may be locally connected with the device 12, 14, 16, 18. In some cases, storage database may be located remotely from the device 12, 14, 16, 18 and accessible to the device 12, 14, 16, 18 across a network for example. In some cases, storage database may comprise one or more storage devices located at a networked cloud storage provider.

The adaptive ROI segmentation device 12 may be a purpose-built machine designed specifically for performing ROI segmentation tasks, image analysis tasks, object (e.g., defect) detection tasks, object (e.g., defect) classification tasks, golden sample analysis tasks, object (e.g., defect) tracking tasks, and other related data processing tasks using an inspection image captured by the camera device 14.

The camera device 14 captures image data. The image data may be of a part or object under inspection or a section or region thereof. The image data may include a single image or a plurality of images. The plurality of images (frames) may be captured by the camera 14 as a video. To image an area of an object to be inspected (which may also be referred to as “inspected object” or “target object”), the camera 14 and the object to be inspected may move relative to one another. For example, the object may be rotated, and a plurality of images captured by the camera 14 at different positions to provide adequate inspection from multiple angles. The camera 14 may be configured to capture a plurality of frames, wherein each frame is taken at a respective position (e.g., if the object is rotating relative to the camera 14).

Generally, the target object may be an object in which defects are undesirable. Defects in the object to be inspected may lead to reduced functional performance of the object or of a larger object (e.g., system or machine) of which the object to be inspected is a component. Defects in the object to be inspected may reduce the visual appeal of the article. Discovering defective products can be an important step for a business to prevent the sale and use of defective articles and to determine root causes associated with the defects so that such causes can be remedied.

The object to be inspected may be a fabricated article. The object to be inspected may be a manufactured article that is prone to developing defects during the manufacturing process. The object may be an article which derives some value from visual appearance and on which certain defects may negatively impact the visual appearance. Defects in the object to be inspected may develop during manufacturing of the object itself or some other process (e.g., transport, testing).

The object to be inspected may be composed of one or more materials, such as metal, steel, plastic, composite, wood, glass, etc.

The object to be inspected may be uniform or non-uniform in size and shape. The object may have a curved outer surface.

The object to be inspected may include a plurality of sections. Object sections may be further divided into object subsections. The object sections (or subsections) may be determined based on the appearance or function of the object. The object sections may be determined to facilitate better visual inspection of the object and to better identify unacceptably defective objects.

The object sections may correspond to different parts of the object having different functions. Different sections may have similar or different dimensions. In some cases, the object may include a plurality of different section types, with each section type appearing one or more times in the object to be inspected. The sections may be regularly or irregularly shaped. Different sections may have different defect specifications (i.e., tolerance for certain defects).

The object to be inspected may be prone to multiple types or classes of defects detectable using the system 10. Example defects types may include paint, porosity, dents, scratches, sludge, etc. Defect types may vary depending on the object. For example, the defect types may be particular to the object based on the manufacturing process or material composition of the object. Defects in the object may be acquired during manufacturing itself or through subsequent processing of the object.

The adaptive ROI segmentation may be trained configured to mask different kinds or types of nROIs.

nROIs may include non-uniform areas of the inspection image in which the object to be inspected is depicted. Non-uniform areas may include components of a target article whose appearance may vary from one article to another and that are not the subject of or relevant to the visual inspection. Such determination of relevance may be made by the user in advance or by the system 10 at the time of processing.

Non-uniform areas may further include improperly illuminated areas or regions. Some visual inspection tasks may require illuminating the target article. Such illumination may translate into the inspection image of the illuminated target article. In some cases, illumination may be complex, such as requiring or using multiple lighting sources. Illumination can lead to non-uniform lighting of the target article (e.g., properly illuminated or well-lit areas, improperly illuminated or poorly lit areas). Non-uniform lighting may cause problems or inefficiencies for downstream image analysis processes, such as defect and anomaly detection (e.g., by introducing false positives). By identifying and masking improperly illuminated regions that are not of interest for the visual inspection system, the system may provide improved image analysis (e.g. defect detection, anomaly detection).

Non-uniform areas may further include surfaces that may potentially generate a large variety of anomalies and/or defects in image analysis, for example, textured surfaces (e.g., casting surfaces on a camshaft). Masking the regions covered by such surfaces may reduce the false positives and improve overall defect and anomaly detection.

The adaptive ROI segmentation device 12 includes a user interface component (or module) (e.g., a human-machine interface). During a training phase of the adaptive ROI segmentation device 12, a user may crop, mask, label, or otherwise block out regions not of interest in the input image through the user interface component (or module). In other embodiments, the ROI segmentation device 12 may programmatically identify nROIs for training samples. Rules may be hardcoded into the adaptive ROI segmentation device 12 before and/or during the training period. During the performance phase of the adaptive ROI segmentation device 12, the adaptive ROI segmentation device 12 may perform that masking without further user input.

The second model device 16 receives data from the adaptive ROI segmentation device 12 via the network 20. The received data may include a masked image from the adaptive ROI segmentation device 12. For example, the masked image data may include the original image data with certain regions cropped out or blocked. Such cropping, blocking, or other forms of masking may include setting all pixels in masked regions to black. All pixels in the masked region may be assigned a pixel value according to what was included in training data. Such setting to black may advantageously signal the second model device 16 not to expend computational resources analyzing the masked region(s) of the image.

The second model device 16 may be an object detection device 16 including one or more models for performing object detection tasks. The second model device 16 may include automatic image annotation software for automatically assigning metadata to the masked image. For example, the inspection image may be annotated with metadata comprising defect data generated by the object detection model such as defect location information (e.g., bounding box coordinates, centroid coordinates), defect size data, and defect class information.

In the system 10, there may be multiple second model devices 16. Each of the second model devices 16 may receive as input the input image from the camera 14, the masked image from the adaptive ROI segmentation device 12, and/or the input image from the camera 14 as modified by the adaptive ROI segmentation device 12 and/or by a previous second model device 16.

The integration device 18 is configured to receive the input image and the masked image, as modified by any of the adaptive ROI segmentation device 12 and the second model device 16. The integration device 18 produces a single output, for example, an image. This output may have some or all of the features or regions identified by the adaptive ROI segmentation device 12 and/or the second model device 16 labelled, delimited, annotated, or otherwise indicated. In some cases, the ROI segmentation device 12, the second model device 16, and the integration device 18 may be implemented as a single device.

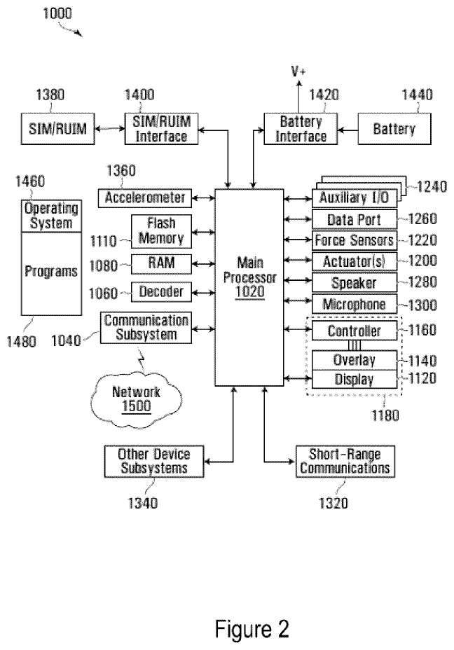

Referring now to FIG. 2, shown therein is a block diagram of a computing device 1000 of the system 10 of FIG. 1, according to an embodiment. The computing device 1000 may be, for example, any one of devices 12, 14, 16, 18 of FIG. 1.

The computing device 1000 includes multiple components such as a processor 1020 that controls the operations of the computing device 1000. Communication functions, including data communications, voice communications, or both may be performed through a communication subsystem 1040. Data received by the computing device 1000 may be decompressed and decrypted by a decoder 1060. The communication subsystem 1040 may receive messages from and send messages to a wireless network 1500.

The wireless network 1500 may be any type of wireless network, including, but not limited to, data-centric wireless networks, voice-centric wireless networks, and dual-mode networks that support both voice and data communications.

The computing device 1000 may be a battery-powered device and as shown includes a battery interface 1420 for receiving one or more rechargeable batteries 1440.

The processor 1020 also interacts with additional subsystems such as a Random Access Memory (RAM) 1080, a flash memory 1110, a display 1120 (e.g., with a touch-sensitive overlay 1140 connected to an electronic controller 1160 that together comprise a touch-sensitive display 1180), an actuator assembly 1200, one or more optional force sensors 1220, an auxiliary input/output (I/O) subsystem 1240, a data port 1260, a speaker 1280, a microphone 1300, short-range communications systems 1320 and other device subsystems 1340.

In some embodiments, user-interaction with the graphical user interface may be performed through the touch-sensitive overlay 1140. The processor 1020 may interact with the touch-sensitive overlay 1140 via the electronic controller 1160. Information, such as text, characters, symbols, images, icons, and other items that may be displayed or rendered on a computing device generated by the processor 1020 may be displayed on the touch-sensitive display 1180.

The processor 1020 may also interact with an accelerometer 1360. The accelerometer 1360 may be utilized for detecting direction of gravitational forces or gravity-induced reaction forces.

To identify a subscriber for network access according to the present embodiment, the computing device 1000 may use a Subscriber Identity Module or a Removable User Identity Module (SIM/RUIM) card 1380 inserted into a SIM/RUIM interface 1400 for communication with a network (such as the wireless network 1500). Alternatively, user identification information may be programmed into the flash memory 1110 or performed using other techniques.

The computing device 1000 also includes an operating system 1460 and software components 1480 that are executed by the processor 1020 and which may be stored in a persistent data storage device such as the flash memory 1110. Additional applications may be loaded onto the computing device 1000 through the wireless network 1500, the auxiliary I/O subsystem 1240, the data port 1260, the short-range communications subsystem 1320, or any other suitable device subsystem 1340.

In use, a received signal such as a text message, an e-mail message, web page download, or other data may be processed by the communication subsystem 1040 and input to the processor 1020. The processor 1020 then processes the received signal for output to the display 1120 or alternatively to the auxiliary I/O subsystem 1240. A subscriber may also compose data items, such as e-mail messages, for example, which may be transmitted over the wireless network 1500 through the communication subsystem 1040.

For voice communications, the overall operation of the computing device 1000 may be similar. The speaker 1280 may output audible information converted from electrical signals, and the microphone 1300 may convert audible information into electrical signals for processing.

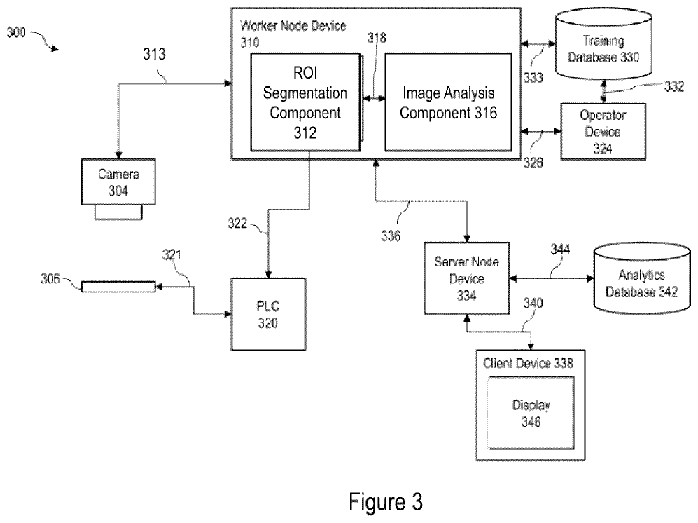

Referring now to FIG. 3, shown therein is a block diagram of a computer system 300 for visual inspection using adaptive ROI segmentation, according to an embodiment. The system 300 can be used to visually inspect a target article. The visual inspection may include any one or more of defect detection, defect classification, and anomaly detection.

The system 300 includes a camera 304. The camera 304 captures image data of a target article 306. The image data may include a single image or a plurality of images. The plurality of images (frames) may be captured by the camera 304 as a video. To image an area of the target article 306, the camera 304 and the target article 306 may move relative to one another. For example, the target article 306 may be rotated and a plurality of images captured by the camera 304 at different positions on the target article 306 to provide adequate inspection from multiple angles. The camera 304 may be configured to capture a plurality of frames, wherein each frame is taken at a respective target article position (e.g. if the target article 306 is rotating relative to the camera 304). The camera 304 may be a USB 3.0 camera or an internet protocol (“IP”) camera.

The system 300 inspects the article 306 and determines whether the article 306 has a defect. Articles 306 may be classified as defective or non-defective by the system 300.

By identifying articles 306 as defective or non-defective, the inspected articles can be differentially treated based on the outcome of the visual inspection. Defective articles 306 may be discarded or otherwise removed from further processing. Non-defective articles 306 may continue with further processing.

The camera 304 is communicatively connected to a worker node device 310 via a communication link 313.

The camera 304 sends the image data to the worker node device 310 via the communication link 313. In an embodiment, the camera 304 captures an image frame at the current target article position and sends the image frame to the worker node device 310.

The worker node device 310 includes an adaptive ROI segmentation component 312. The adaptive ROI segmentation component 312 receives the inspection image as input and generates a masked image as output. The masked image includes ROIs and non-ROIs. The nROIs correspond to masked regions of the masked image. The masked image is provided to the image analysis component 316 for analysis. The image analysis component 316 may perform defect and/or anomaly detection on the masked image. By providing the image analysis component 316 with the masked image, the image analysis component 316 may be able to function more efficiently than it would having received the inspection image directly, such as by focusing image analysis on ROIs and disregarding non-ROIs.

The image analysis component 316 may include a machine learning (ML) model. The ML model is used as part of the defect detection process. The ML model may be a neural network (NN). The neural network may be a convolutional neural network (CNN). The neural network may perform an object detection (OD) task. The neural network may perform an image classification task.

In an embodiment, the image analysis component 316 is configured to generate output data identifying the presence of a defect in the image. The output data may include any one or more of a defect class, a defect location, a defect size, and a defect confidence level. The defect location may be defined by a bounding box. The output data may be in the form of an annotated inspection image. For example, the annotated inspection image may include a bounding box enclosing the defect and a class label identifying the defect type. In some embodiments, the image analysis component 316 is configured to generate output data identifying another type of artifact in the image, such as an anomaly.

In an embodiment, the image analysis component 316 includes an object detection component for performing object detection.

The object detection component may be configured to perform an object detection process on the image data to detect defects in the image data. Generally, the object detection process determines whether a defect (or defects) is present in the image data or not.

The object detection component may be further configured to perform a defect classification process to classify defect types (i.e., assign a defect class to a detected defect). Defect classification can be performed on an input provided from the object detection process. The defect classification process may be invoked upon the detection of one or more defects in the image data. The defect classification process assigns a class label (e.g., defect name or defect type, such as “scratch”) to the defects provided from the object detection process. In some embodiments, the object detection component includes an object detection model and an object classification model. The object detection model generates an object class for each detected object. Image data including the detected object is provided to the object classification model, which outputs an object class. The object detection component compares the object class determined by the object detection model with the object class determined by the classification model to confirm the class label for the object. Where the class label is not confirmed by the classification model, the object detection component may be configured to disregard the detection.

The object detection component may use artificial intelligence, neural networks, or other means to identify objects, parts thereof, proper assembly of those parts, and/or defects therein in the region of interest indicated by the input, such as a masked image, received from the adaptive ROI segmentation component 312. Through use of the masked image, the object detection component may operate more efficiently with respect to time and computational resources than might otherwise be possible if object detection were performed with respect to the input image as provided by the camera 304.

In an embodiment, the image analysis component 316 includes a golden sample component for performing golden sample (GS) image analysis. The golden sample component may be a generative golden sample component (for generating a GS image from the inspection image) or not. A golden sample component that is not a generative GS component may have a bank of GS images from which to retrieve the appropriate GS image.

The golden sample component may have an image comparison component (not shown). The image comparison component analyzes the GS and the inspection image and identifies artifacts corresponding to differences between the GS image and the inspection image. Generally, as the GS image represents a “perfect” or “clean” image, the artifacts are present in the inspection image and not in the GS image. In an embodiment, the inspection image and GS image are each provided to a pretrained CNN to generate respective feature maps. The feature maps are compared/analyzed to identify the artifacts. In another embodiment, the GS and inspection images are compared using matrix subtraction or pixel to pixel greyscale subtraction to generate an output identifying the artifacts. Results of the image comparison component may be used in subsequent processing operations, such as to detect anomalies and identify new types or classes of defects. For example, outputs of the golden sample component (identified differences, or objects) and the object detection component (detected objects) may be compared.

The golden sample component may include an image classification model. The image classification model receives an input image containing an artifact detected by the image comparison component. The input image may be a cropped version of the inspection image including the artifact. The image classification model is configured to determine a class label and assign the class label to the artifact. The image classification model may be a binary classifier configured to assign a defect label or an anomaly label to the input image.

The golden sample component may use artificial intelligence, neural networks, or other means to create an idealized representation of a region of interest indicated by the input, such as a masked image, received from the adaptive ROI segmentation component 312. This idealized representation is referred to as a “golden sample” or golden sample image”. This golden sample may represent an image of an object or part without any defects or improper assembly so that a comparison may be made between the golden sample of the masked image and the masked image itself. Through use of the masked image, the golden sample component may operate more efficiently with respect to time and computational resources than might otherwise be possible if the golden sample were created with respect to the input image as provided by the camera 304.

The object detection component and the golden sample component may be communicatively connected via a communication link within the ROI segmentation component 312. The communication link may include an application programming interface (API) or the like.

The object detection component and the golden sample component may each have their own designated hardware component (not shown). For example, the object detection component may run on a first embedded device and the golden sample component may run on a second embedded device. The embedded device may be an embedded device specially configured for performing artificial intelligence-type tasks. In an embodiment, the embedded device is a JETSON box.

In an embodiment, the image analysis component 316 includes the OD component, the GS component, and an integration component. The integration component may be implemented at the integration device 18 of FIG. 1. The integration component is configured to receive output data from the OD component (e.g., describing any defects found in the inspection image) and the GS component (e.g., describing any defects or anomalies found in the inspection image). The integration component compares the OD output data and GS output data. Comparing may include comparing location data of defects/anomalies in the respective outputs. The integration component may confirm a defect where location data is found to correspond (e.g. within a threshold) between the OD and GS outputs.

When provided with a masked image from the adaptive ROI segmentation component 312, the image analysis component 316 may instead perform object detection functions at the object detection component and/or may perform golden sample functions at the golden sample component. The integration component may then perform comparison functions.

Either or both of the object detection component and the golden sample component may be housed within one or more image analysis components 316. The image analysis components 316 may include further models and/or components for analyzing the input image and/or the masked image.

The integration component may integrate the information and determinations made with respect to the input image and/or the masked image in order to produce an output image. The output image is received at the client device 338 and displayed to the user. The output image may be an annotated inspection image including visually identified defects or anomalies detected by the image analysis component 316. The output image may be displayed to the user at display 346 of the client device 338. The integration component through the client device 338 may provide all or only some of the information produced by the object detection component, the golden sample component, and/or any further models and/or components of the image analysis component 316. The output to the user at the client device 338 may include either the input image or the masked image with such information annotated thereon or provided therewith. In a further embodiment, the output to the user at the client device 338 may include the information presented independent of the input image or the masked image.

The devices, components, and databases of the system 300 communicate with one another through communication links, such as communication link 313, herein depicted as connecting the camera 304 and the adaptive ROI segmentation component 312. It will be appreciated by a person of skill in the art that such communication links may exist between and among more, fewer, and all devices, components, and databases of the system 300.

The system 300 also includes a PLC device 320. The PLC device 320 is communicatively connected to the worker node device 310 via a communication link 322.

The PLC device 320 is configured to control the manipulation and physical processing of the target article 306. This may be done by sending and receiving control instructions to an article manipulating unit (not shown) via communication link 321. Such manipulation and physical processing may include rotating or otherwise moving the target article 306 for imaging and loading and unloading target articles 306 to and from an inspection area. An example instruction sent by the PLC 320 to the article manipulating unit via the communication link 321 may be “rotate target article by ‘n’ degrees”. In some cases, the transmission of such instruction may be dependent upon information received from the worker node device 310 (e.g., the object detection component 314).

The PLC 320 may store defect tolerance data. The defect tolerance data may include a defect class identifier unique to a particular defect class and one or more tolerance values linked to the defect class identifier. In other embodiments, the defect tolerance data may be stored on another device, such as the worker node device 310. The defect tolerance data may be stored in a defect tolerance database. Defect tolerance data in the defect tolerance database may be referenced using the defect class identifier to facilitate retrieval of tolerance data values for comparison to data generated by the worker node device 310 (e.g., via components 314, 316).

For example, in an embodiment, the PLC 320 is configured to receive data from the worker node device 310 via the communication link 322 indicating the outcome of the defect detection process. For example, where a defect has been detected by the object detection component 314, defect data may be sent to the PLC 320. The PLC 320 stores the defect tolerance data. The PLC 320 analyzes the defect data in view of the tolerance data to determine whether the target article 306 is defective (e.g., “NG”) or within tolerance (e.g., “OK”). The PLC 320 may send a signal to the worker node device 310 indicating the outcome of the tolerance analysis. Where the PLC 320 determines the defect data is out of tolerance, the PLC 320 may stop the inspection of the target article 306 and initiate a process for the removal of the defective target article and loading of a new target article. The PLC 320 may generate a control signal for stopping inspection of the target article and transmit the control signal to an actuator responsible for manipulating the target article 306.

In cases where the object detection component 314 has not detected a defect in the inspection image, the worker node device 310 (e.g., via the object detection component 314) sends a signal to the PLC 320 indicating the outcome of the object detection process which indicates no defects were found in the image (e.g., “OK”). Upon receiving the OK message, the PLC 320 sends a control signal to an actuator or manipulator of the target article 306 to adjust the current inspection position of the target article 306 (e.g., rotate the target article 306 by ‘n’ degrees).

In other embodiments, the defect tolerance data may be stored at the worker node device 310 and the tolerance analysis performed by the worker node device 310. The worker node device 310 may then send a signal to the PLC 320 indicating whether the target article is defective or not.

The system 300 also includes an operator device 324. The operator device 324 is communicatively connected to the worker node device 310 via a communication link 326.

The operator device 324 includes a user interface component (or module) (e.g., a human-machine interface). The operator device 324 receives data from the worker node device 310 via the communication link 326. The received data may include output data from the image analysis component 316 of the worker node device 310. For example, the output data may include an annotated inspection image including artifact data. The artifact data may include location information (e.g., coordinates, bounding box) and label information such that artifacts (e.g., defects, anomalies) in the inspection image that were identified by the worker node device 310 can be identified visually in a displayed image.

The worker node device 310 or the operator device 324 may include automatic image annotation software for automatically assigning metadata comprising data generated by the image analysis component 316 to a digital inspection image.

The operator device 324 provides the output data from the worker node device 310 to the user interface component which generates a user interface screen displaying the annotated inspection image. For example, the inspection image may be annotated with metadata including defect data generated by the components such as defect location information (e.g. bounding box coordinates, centroid coordinates), defect size data, and defect class information.

The user interface component of the operator device 324 may also render one or more user interface elements for receiving input from the operator. For example, the user interface component may provide a yes/no or similar binary option for receiving user input data indicating a selection of an option. In a particular case, the user interface may present and highlight a particular object detected by the worker node device 310 in an annotated inspection image and ask whether the object is an anomaly or not (and receive a corresponding input from the user).

Depending on the input data received from the user, the annotated inspection image (or a portion thereof), may be routed differently in the system 300. For example, upon the user interface component of the operator device 324 receiving certain input data (e.g., an answer “no” to a question of whether a given artifact is an anomaly, such as by the user clicking on a user interface element labelled “no”), the operator device 324 or the worker node device 310 may be configured to send the annotated inspection image (or a subset of the image data) to an ML model training database, such as the training database 330, via communication link 332 or 333, respectively. The data received by the ML model training database 330 can be logged as a training sample for a future training dataset that can be used to further train one or more artificial intelligence components of the worker node device 310.

The operator device 324 may be used in a training phase of the ROI segmentation component 312. For example, inspection images may be displayed in a user interface at the operator device 324 (training sample annotation user interface). A user may input data via the user interface identifying nROIs in the inspection images. In some cases, the user may identify nROIs by defining the ROIs in the image (i.e. the nROIs are those regions of the image that are not identified as ROIs). The resulting images with nROIs identified comprise training samples which may be added to a training database 330 and used in training (or retraining or updating) the ROI segmentation component 312. Once trained, the system 300 and specifically the adaptive ROI segmentation component 312 may be able to perform adaptive ROI segmentation without further user input through reliance on the training database 330.

The system 300 also includes a server node device 334. The server node device 334 is communicatively connected to the worker node device 310 via a communication link 336. In particular, the server node device may be in communication with the image analysis component 316 of the worker node device 310 via the communication link 336. The server node device 334 may include a Jetson device or the like.

The server node device 334 receives visual inspection data from the worker node device 310. The visual inspection data includes output data (or “defect data”) from the image analysis component 316. The defect data may include whether a defect was found or not found, a unique defect identifier for each detected defect, a number of defects found, whether a target article is defective or not defective, location of defect (defect location data, such as bounding box coordinates), a defect class identifier, or the like. The server node device 334 includes a visual inspection analytics component configured to analyze the received defect data.

The server node device 334 is communicatively connected to a client device 338 via a communication link 340. In some cases, the client device 338 may include the server node device 334 (i.e., the server node device 334 is a component of the client device 338).

The server node device 334 is also communicatively connected to an analytics database 342 via a communication link 344. The analytics database 342 stores analytics data as well as visual inspection output data from the worker node device 310 (e.g., defect data).

The defect data may be stored such that a database record is generated and maintained for each inspected target article 306. The record may include a target article identifier, which may be captured from the target article itself (e.g., a code on the article captured by the camera) or automatically generated by the server node device 334. Various defect data may be associated with or linked to the database record for the target article 306. Each defect may be assigned a unique identifier to which other data about the defect can be linked.

The analytics data may be generated by the server node device 334 from the visual inspection data. The analytics data may be generated by the application of statistical analysis techniques to the visual inspection data. The analytics data may provide insight to an operator or other user as to the determinations made by the system 300 across a number of target articles 306.

The client device 338 includes a user interface component configured to provide a graphical user interface via a display 346. The user interface component receives analytics data form the server node device 334 and displays the analytics data via the graphical user interface on the display 346. In some cases, the server node device 334 and the user interface component are configured to update the graphical user interface in real-time upon the server node device 334 receiving visual inspection data from the worker node device 310.

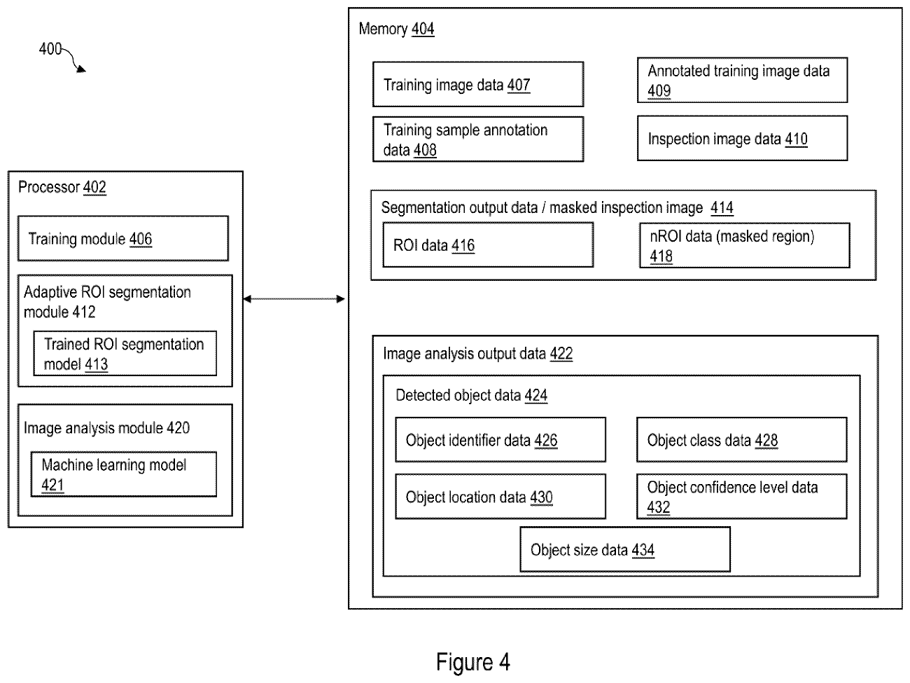

Referring now to FIG. 4, shown therein is a computer system 400 for visual inspection using adaptive ROI segmentation, according to an embodiment. The computer system 400 may be implemented at one or more devices of the computer system 10 of FIG. 1. For example, components of the computer system 400 may be implemented by any one or more of the adaptive ROI segmentation device 12, the second model device 16, and the integration device 18 of FIG. 1. The computer system may be implemented at one or more devices of the system 300 of FIG. 3. For example, components of the computer system 400 may be implemented at the worker node device 310 of FIG. 3.

The system 400 includes a processor 402 for executing software models and modules.

The system 400 further includes a memory 404 in communication with the processor 402 for storing data, including output data from the processor 402.

The memory 404 stores inspection image data 410 corresponding to an inspection image. The inspection image may be generated and provided by the camera 304 of FIG. 3.

The processor 402 includes a training module 406 for training an adaptive ROI segmentation model (e.g. ROI segmentation model 413). The training module 406 receives user input indicating nROIs (or ROIs) in an input image to be used in training the ROI segmentation model. The user input is stored in the memory 404 as training sample annotation data 408. The training module 406 annotates the input image using the training sample annotation data 408 to generate a training image. The training image is stored in memory 404 as training image data 407 (e.g., as part of a training dataset comprising a plurality of training images). In some cases, the training module 406 may perform the training image annotation programmatically or automatically without user input.

The processor 402 further includes an adaptive ROI segmentation module 412. In cooperation with an adaptive ROI segmentation module 412, there is a training phase that uses the training module 406 to train an adaptive ROI segmentation model 413. The memory 404 stores training image data 407. The training module 406 is configured to display the training image data 407 in a user interface (not shown). The user reviews the training image data 407 and inputs the training sample annotation data 408 via the user interface to the training module 406. The training sample annotation data 408 indicates masked non-ROI regions in the training image data 407. The training module 406 uses the training sample annotation data 408 to annotate the training image data 407, generating annotated training image data 409 (masked training image data). The annotated training image data 409 is stored in the memory 404. The user may provide the training sample annotation data 408 manually, for example through blacking out non-ROI regions through known photo alteration techniques and/or software.

In an embodiment, the training module 406 may be configured to train the adaptive ROI segmentation model 413 to perform ring segmentation. The training module 406 may include software code configured to find two circles with predetermined diameters and use a circle detection algorithm to extract inner and outer circles. The training module 406 uses the extracted inner and outer circles to draw ROI masks on the training image data 407. Accordingly, the trained adaptive ROI segmentation model 413 (e.g., trained network) may then be able to generalize so as to draw such rings without further depending on the circle detection algorithm (which may, for example, be slower than deep-learning networks and which may fail in complex tasks with multiple circular objects present).

The training module 406 is further configured to implement a training process using the training image data 407 and the annotated training image data 409. The training image data 407 and corresponding annotated training image data 409 may be used by the training module 406 to learn model configurations for an autoencoder-type model and generate a trained ROI segmentation model 413 through a learning process. The model training process employed by the training module 406 may be the same or similar to a model training process for a typical autoencoder.

The adaptive ROI segmentation module 412 generates a masked image. nROIs in the masked image may be cropped out of the image by providing the output image to other image processing algorithms. The adaptive ROI segmentation module 412 may generate a masked output image including nROIs blocked by setting pixels in the nROIs to black (black pixels being nil and not containing any content).

The adaptive ROI segmentation module 412 includes the trained ROI segmentation model 413. The trained model 413 may have been generated by the training module 406. The adaptive ROI segmentation module 412 may function similarly to the adaptive ROI segmentation device 12. The trained ROI segmentation model 413 may be structurally and functionally similar to existing autoencoders. The trained ROI segmentation model 413 may be configured to down sample the inspection image data 410 using convolutional layers and map the inspection image data 410 to a latent vector. The trained ROI segmentation model 413 may then up sample the inspection image data 410 and generate an output image.

Through communication between the memory 404 and the processor 402, the inspection image data 410 is fed to the adaptive ROI segmentation module 412 and provided as input to the ROI segmentation model 413. The ROI segmentation model 413 generates segmentation output data 414 as output. The segmentation output data 414 is stored in the memory 404. The segmentation output data 414 may comprise a masked image in which nROIs are masked. For example, the segmentation output data 414 may be an image in which nROIs are painted in block (similar to the annotated training image data 409).

The segmentation output data 414 includes ROI data 416, which indicates one or more regions of interest (ROIs) in the inspection image data 410. The segmentation output data 414 further includes nROI data 418, which indicates one or more regions that are not of interest in the inspection image data 410 (and thus are masked). Either or both of the ROI 416 and the nROI 418 may be in the form of the input image with ROIs highlighted and/or nROIs cropped, blocked, blacked-out, or otherwise masked.

The processor 402 further includes an image analysis module 420. The image analysis module 420 includes one or more machine learning models 421, such as a neural network, for detecting objects in an input image. The objects that the machine learning model 421 is trained to detect may be defects. For example, the machine learning model 421 may be configured to detect or classify one or more categories or types of defects in an input image. The machine learning model 421 may be an object detection model. The machine learning model 421 may be an image classification model. The machine learning model 421 may be a neural network, such as a CNN, configured to detect features in an input image (e.g. the masked inspection image 414).

The image analysis module 420 receives and analyzes the masked inspection image 414 to detect objects/artifacts in the masked inspection image using the machine learning model 421. In particular, the analysis of the masked inspection image 414 is limited to the ROIs 416 determined by the ROI segmentation model 413.

Through communication between the memory 404 and the processor 402, the inspection image data 410, the ROI data 416, and/or the nROI data 418 may be fed to the image analysis module 420.

The image analysis module 420, using the machine learning model 421, generates image analysis output data 422. For example, in embodiments where the machine learning model 421 includes an object detection model, the image analysis output data 422 includes object detection output data.

In some cases, the image analysis output data 422 may be an annotated inspection image (e.g., annotated with detected object data, such as described below).

The image analysis output data 422 includes detected object data 424. The detected object data 424 describes one or more objects identified in the ROIs 416 (masked inspection image 414) by the image analysis module 420. The objects may be defects. The objects may be anomalies.

The detected object data 424 includes object identifier data 426. The object identifier data 426 may include a unique identifier (generated by the image analysis module 420) for each detected object.

The detected object data 424 may include object class data 428. The object class data 428 may include a class label assignment for each detected object. The class label may correspond to a particular category, class, or type of defect.

The detected object data 424 may include object location data 430. The object location data 430 may include location data for each detected object defining a location of the detected object in the inspection image. For example, the object location data 430 may be in the form of a bounding box enclosing the detected object in the ROI 416, the masked inspection image 414, or the inspection image 410.

The detected object data 424 may include object confidence level data 432. The object confidence level data 432 indicates a confidence level for each detected object.

The detected object data 424 may include object size data 434. The object size data may include size data identifying a size for each detected object.

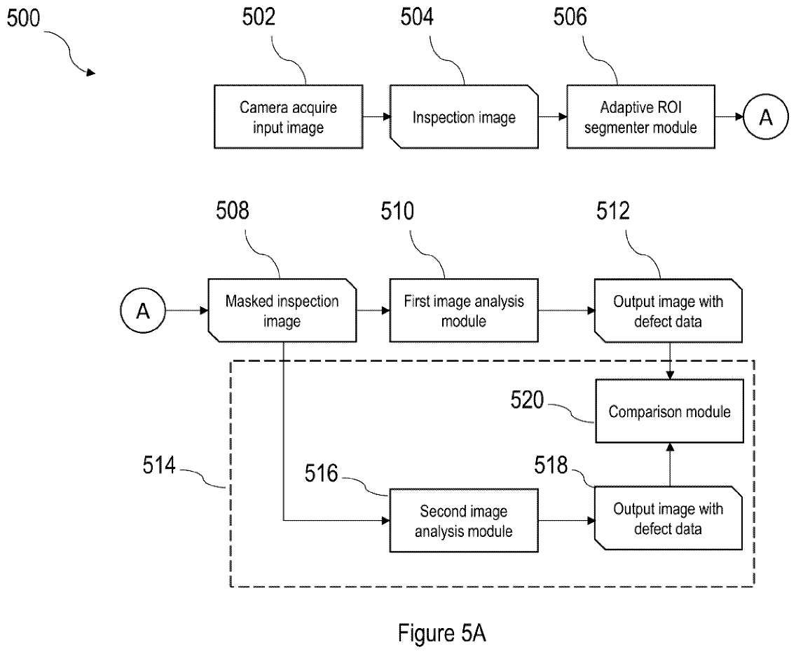

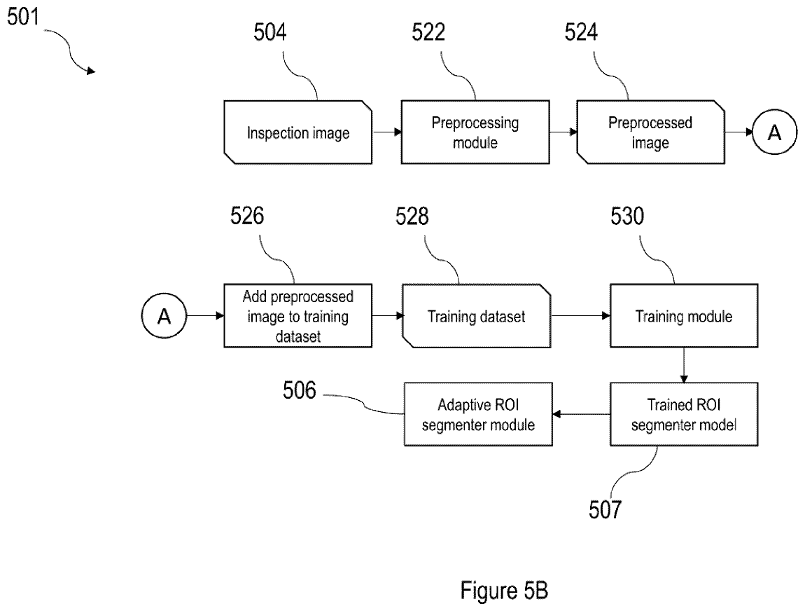

Referring now to FIG. 5A, shown therein is a defect detection pipeline 500 using ROI segmentation, according to an embodiment. The pipeline 500 is implemented by a visual inspection system, such as the system 300 of FIG. 3 or the computer system 400 of FIG. 4.

At 502, the camera 304 images a target article 306. The imaging operation generates an inspection image 504 (e.g. inspection image 410 of FIG. 4).

The inspection image 504 is provided to an adaptive ROI segmenter module 506 for performing adaptive ROI segmentation and masking nROIs (e.g. nROIs 418 of FIG. 4). The ROI segmenter module 506 may be the ROI segmentation module 412 of FIG. 4.

The adaptive ROI segmenter module 506 generates a masked inspection image 508 through identifying and masking nROIs in the inspection image. The masked inspection image 508 may be the inspection image 504 with non-ROI regions cropped out or otherwise blacked out. The masked inspection image 508 may advantageously cause subsequent analysis to be more efficiently directed to ROIs.

The masked inspection image 508 is provided to a first image analysis module 510 for performing defect detection. The first image analysis module 510 is configured to analyze only ROIs and ignore nROIs as identified by the ROI segmenter module 506.

The first image analysis module 510 generates an output image 512 with defect data. The defect data identifies defects detected in the masked inspection image. The defect data may be the detected object data 424 of FIG. 4. The output image 512 may take the form of an annotated version of either the inspection image 504 or the masked inspection image 508 with annotations describing detected defects (such as labels, class labels, bounding boxes, and/or coordinates).

The pipeline 500 includes an optional component 514.

In the optional component 514, the masked inspection image 508 is also provided to a second image analysis module 516 for performing defect detection. The second image analysis module 516 is configured to analyze only ROIs and ignore non-ROIs as identified by the ROI segmenter module 506.

The second image analysis module 516 generates an output image 518 with defect data. The defect data identifies defects detected in the masked inspection image. The defect data may be the detected object data 424 of FIG. 4. The output image 518 may take the form of an annotated version of either the inspection image 504 or the masked inspection image 508 with annotations describing detected defects (such as labels, class labels, bounding boxes, and/or coordinates).

The output images 512, 518 are provided to a comparison module 520 for comparing defects detected by the first image analysis module 510 and the second image analysis module 516. The comparison module 520 may be configured to confirm a defect in the inspection image 504 and/or the masked inspection image 508 where the defect is determined by the comparison module 520 to be present in both output images 512 and 518. The comparison may be performed using defect location data of defects in the respective output images 512, 518 (e.g. object location data 430 of FIG. 4). Where the comparison module 520 confirms a defect, it may further classify the defect.

The first image analysis module 510 and second image analysis module 516 may perform defect detection through different techniques and/or models. For example, the first image analysis module may perform defect detection according to object detection techniques and/or models, while the second image analysis module may perform defect detection according to golden sample techniques and/or models.

Referring now to FIG. 5B, shown therein is a training pipeline 501 of a visual inspection system for defect detection using ROI segmentation, according to an embodiment. The training pipeline 501 may be implemented by the training module 406 of FIG. 4.

In the pipeline 501, an inspection image 504 is provided to a preprocessing module 522, which generates a preprocessed image 524. The preprocessed image 524 may take the form of an annotated version of the inspection image 504 with annotations identifying ROIs and nROIs. The annotations may be provided by a user in a supervised or semi-supervised fashion. The annotations may alternately be provided by a program and may be based on a position or rotation of an object (that is being inspection) within the inspection image 504. For example, in some cases the object to be inspected is rotated or otherwise moved during inspection and a plurality of images are acquired. In such cases, metadata may be associated with the inspection image indicating a position or rotation of the object such that it is known at what position or rotation the image was taken. This position information can be leveraged by the preprocessing module to automatically identifying ROIs and nROIs.

The preprocessing module 522 may perform preprocessing through providing the inspection image 504 to a user (e.g., by displaying the inspection image 504 in a user interface). The user can then indicate, by providing input data to the user interface, ROIs and nROIs in the inspection image 504 (e.g. by cropping or blacking out the nROIs manually). Such user cropping or blacking out may occur through known photo alteration techniques and/or software (e.g. photoshop or the like). In other cases, the preprocessing module 522 may be configured to preprocess the image automatically, for example, according to ML and/or CNN techniques. The preprocessed image 524 may have nROIs cropped or otherwise blacked out.

At 526, the preprocessed image 524 is added to a training dataset 528 for training an ROI segmentation model.

The training dataset 528 is used to construct a training module 530 for training an ROI segmenter model and generating the trained ROI segmenter model 507.

The trained ROI segmenter model 507 can be incorporated into the adaptive ROI segmenter module 506.

The pipelines 500 and 501 may intelligently crop the inspection image 504 to remove nROIs and limit input to the trained model 507 of the ROI segmenter module 506.

The masking of non-ROI's may be advantageous in the case of downstream algorithms that may require perfect illumination on the surface of an object in the inspection image in order to perform accurate inspection thereof.

As a further example, masking may be advantageous where adaptive ROI segmentation is used to form a stitched image from area scan cameras. Non-overlapping areas of the images may be cropped to add to the output image.

As a further example, in medical applications, it may be necessary to run a diagnosis algorithm (e.g. image analysis using a machine learning model) on predetermined parts of the tissue. For example, a user, such as a medical professional, may acquire an image of a tissue of an individual for the purpose of diagnosing a condition of an individual (i.e. determining whether a particular medical condition is present in the individual). The image may be masked using the adaptive ROI segmentation techniques of the present disclosure. In particular, ROIs determined by ROI segmentation may correspond with one or more predetermined regions or parts of the tissue which are of interest for diagnosis, while nROIs may correspond to other parts or regions of the tissue not of interest (and which are thus masked). The masked image can be provided to a downstream image analysis process using a machine learning model (e.g. object detection, classification). The analysis by the machine learning model is limited to ROIs. In doing so, the chances of false positives, such as by detecting something in the image in an nROI, may be reduced.

The ROI of an object to be inspected in the inspection image 504 may vary by application. For example, in the context of visual inspection of camshafts, the ROI may be the region of the camshaft image where there is uniform illumination (e.g. center of the camshaft). Anomaly detection tasks which may be performed downstream of the adaptive ROI segmentation may have different requirements for different regions of the inspection image 504. Further, all image pixels of the inspection image 504 may not be used for inspection, and masking image pixels that are not used in inspection may reduce false positives.

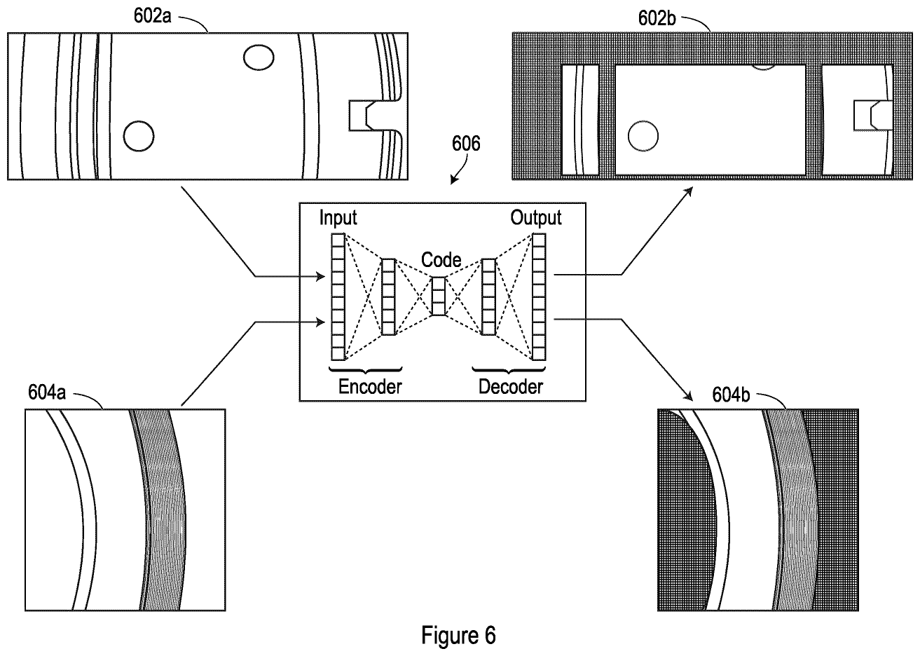

Referring now to FIG. 6, shown therein are illustrations of example images 602a, 602b, 604a, and 604b, as well as logic 606, corresponding to the systems and devices herein disclosed, according to an embodiment. The images 602a, 602b, 604a, 604b may be processed by the computer system 400 of FIG. 4 using the logic 606. The logic 606 represents a trained ROI segmentation model, such as the model 413 of FIG. 4.

Sample input image 602a depicts an input image (such as inspection image data 410) of a camshaft under inspection before adaptive ROI segmentation has been applied thereto. Specifically, input image 602a depicts a journal section of a camshaft.

The input image 602a is provided to the ROI segmentation model 606, which generates output image 602b.

The output image 602b is a masked inspection image. The output image 602a includes ROIs and nROIs. The nROIs have been masked with black pixels by the model 606. Masked regions in the output image 602b are illustrated using a hatch pattern (representing black pixels). The masking of the nROIs may advantageously limit subsequent processing of the inspection image by other models to only the ROIs.

Output image 602b is a journal with non-uniform areas masked. Seal rings in output image 602b have been masked. The adaptive ROI segmentation has been configured to mask the seal rings because the appearance of the seal rings may vary from one camshaft to another. If the seal rings were not masked in the output image, the seal rings may negatively affect downstream image analysis processes, such as anomaly detection (e.g., by producing a false positive). Improperly illuminated areas in the output image 602b have been masked. Casting surfaces are also masked in output image 602b. The casting surfaces have a texture which, if presented to a downstream image analysis process such as anomaly detection, may have the potential to trigger false positives, i.e., unwanted detections.

Sample input image 604a is another example input image of a camshaft under inspection before ROI segmentation has been applied. Specifically, input image 604a depicts a thrust section of a camshaft. The input image 604a is provided to the ROI segmentation model 606, which generates output image 604b. The output image 604b is a masked image (like output image 602b).

The output image 604b includes ROIs and nROIs. The nROIs have been masked with black pixels by the model 606. Masked regions in the output image 604b are illustrated using a hatch pattern (representing black pixels). The trained ROI segmentation model 413 is trained to create an enhanced image of the thrust area (due to poor lighting conditions of the input image 604a). In the output image 604b, a casting surface present in the input image 604a is masked. As previously noted, presenting a casting surface for downstream image analysis such as anomaly detection may produce unwanted detections due to the texture of the casting surface.

Model 606 is a denoising autoencoder set up to learn a segmentation task. The layers, cost function, and weights of the denoising autoencoder 606 may vary from one inspection task to another. For example, when input image 602a is used to generate output image 602b, the contents of the input image 602a are downsampled to a latent space (code). During a reconstruction phase, non-ROI's in the image data are converted to black pixels.

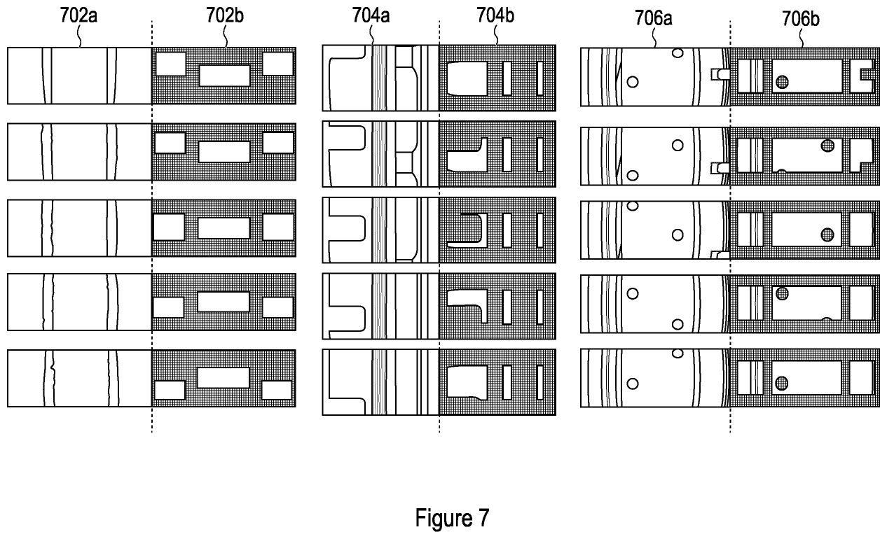

Referring now to FIG. 7, shown therein are illustrations of example input and output image pairs processed by an ROI segmentation module of the present disclosure, according to an embodiment. The input-output image pairs depict a camshaft that is being rotated while under inspection, with images captured at different points of rotation. The input and output images may be generated and processed by the system 300 of FIG. 3. The input images may be inspection image data 410 of FIG. 4. The output images may be the segmentation output data 414 of FIG. 4.

Each of columns 702a, 704a, and 706a include input images (such as inspection image data 410) before adaptive ROI segmentation has been applied thereto. After adaptive ROI segmentation has been performed according to, for example, the logic 606 of FIG. 6 or adaptive ROI segmentation module 412 of FIG. 4. Columns 702b, 704b, 706b include output images which have been generated by the ROI segmentation process being applied to the corresponding input image (e.g. input image in first row of 702a corresponds to output image in first row of 702b). The output images are masked inspection images (i.e. masked versions of the corresponding input images). The masked inspection images include masked regions which correspond to nROIs. The ROIs are not masked. The nROIs in the output images 702b, 704b, and 706b have been masked with black pixels. In FIG. 7, masked regions in the output images 702b, 704b, 706b are illustrated using a hatch pattern (representing black pixels). This masking may advantageously confine subsequent processing by other models to only the ROIs in the respective output images 702b, 704b, 706b.

As previously noted, the input-output image pairs depict a camshaft under inspection being rotated while being inspected. Accordingly, it can be seen in the image pairs how the ROIs may change or move as the camshaft is rotating. In columns 702a and 702b, a well-lit area of a camshaft is being tracked over multiple frames. In columns 704a and 704b, a vacuum slot opening is being masked over multiple frames without missing any area of the machined surface. Furthermore, a sensor ring is also being masked, as it is not an area that requires inspection. In columns 706a and 706b, VTC oil holes and a stepper motor notch are being masked over multiple frames successfully.

The system 10 for visual inspection may be used to visually inspect machined surfaces. Machined surfaces may be particularly suitable for visual inspection using machine learning or computer vision processes, such as described herein. The system 10 may further be used to visually inspect an article including a machined surface. The article may include other parts, components, regions, etc. other than the machine surface to be inspected. Such other parts, components, regions, etc. may be captured and present in image data of the article used for visual inspection. Further, other aspects not part of the article may also be included in the image data. Visual inspection may be focused on the machined surface.

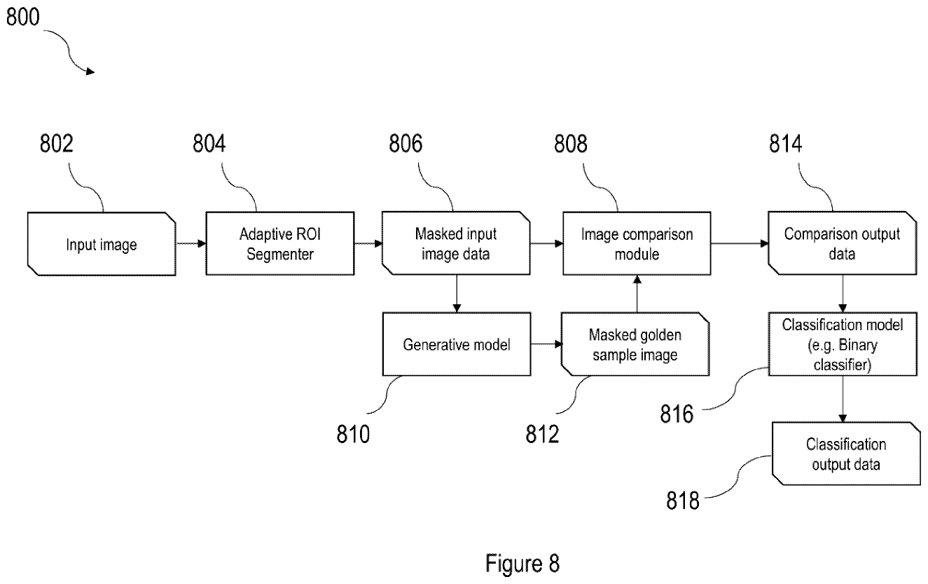

Referring now to FIG. 8, shown therein is a visual inspection processing pipeline 800 for golden sample image analysis using adaptive ROI segmentation, according to an embodiment. The pipeline 800 may be implemented, for example, using system 300 of FIG. 3 or computer system 400 of FIG. 4.

The pipeline 800 starts with an input image 802 (e.g., inspection image data 410). The input image 802 may an inspection image of the target article 306 captured by the camera 304.

The input image 802 is provided to an adaptive ROI segmenter (e.g., adaptive ROI segmentation module 412 of FIG. 4). The adaptive ROI segmenter 804 generates masked input image data 806.

Masked input image data 806 contains a mask. The mask covers nROIs in the input image data 802 identified by the ROI segementer 804. The masking of the nROIs may be performed by setting the pixels of nROIs in the input image 802 to black. This may include specifically setting pixels in nROIs to black or setting all pixels in the image that are outside ROIs to black.

The masked input image data 806 is provided to a generative model 810. The generative model 810 generates a masked golden sample image 812.

Advantageously, because nROIs have been masked in masked input image data 806, the generative model 810 does not perform its generation with respect to those regions. Accordingly, generative model 810 may proceed more efficiently and effectively through avoiding unnecessary processing of regions not of interest as identified by the adaptive ROI segmenter 804.

The masked input image 806 and the masked golden sample image 812 are each provided to an image comparison module 808.

The image comparison module 808 performs a direct image comparison of the masked input image data 806 and the masked golden sample image 812 (i.e., of the masked input image data before and after proceeding through the generative model 810) and generates comparison output data 814. The comparison output data 814 may include one or more detected objects (or artifacts). A detected object in this context refers to an object or artifact present in the masked input image 806 and not in the masked golden sample image 812. In other words, the detected object represents a detected difference between the images 806, 812.

The image comparison module 808 may compare the images 806, 812 on a pixel-by-pixel basis. In an embodiment, the direct image comparison is performed using matrix subtraction or pixel to pixel greyscale subtraction. Advantageously, such comparison may proceed more efficiently due to the presence of masking, as nROIs may be ignored, obviating the need for the image comparison module 808 to perform comparisons in respect of such regions.

The comparison output data 814 may be provided to classification model 816 for classification of objects found by the image comparison module 808 (for example, defects, part identification). In some cases, objects identified by the image comparison module 808 may be cropped from the masked input image and the cropped image including the object provided to the classification model 816 for image classification of the cropped image.

The classification model 816 generates classification output data 818. The classification output data 818 includes a class label assigned to the object being classified (e.g. defect type, defect vs. anomaly). Classification output data 818 may advantageously be produced more efficiently and effectively due to the presence of masking as provided by the adaptive ROI segmenter 804 through avoiding unnecessary processing and computation. Further, the adaptive ROI segmenter 804 may advantageously reduce the load required of the classification model 816 by preventing false positive detections in nROIs from being sent to and processed by the classification model 816 (as such nROIs are masked).

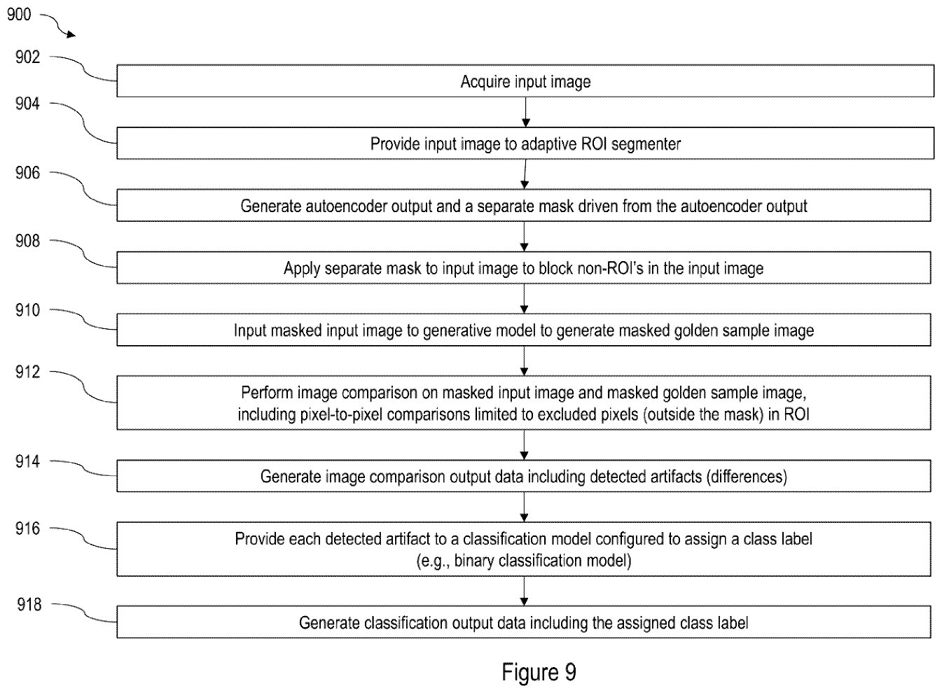

Referring now to FIG. 9, shown therein is a method 900 of visual inspection using the visual inspection processing pipeline 800 of FIG. 8, according to an embodiment.

At 902, the input image 802 is acquired.

At 904, the input image 802 is provided to the adaptive ROI segmenter 804.

At 906, autoencoder output is generated and a separate mask is derived as driven from the autoencoder output.

At 908, the separate mask is applied to the input image 802 to block regions not of interest in the input image 802. The result is the masked input image data 806.

At 910, the masked input image data 806 is inputted to the generative model 810 in order to generate the masked golden sample image 812.

At 912, the image comparison module 808 performs image comparison between the masked input image data 806 and the masked golden sample image 812. Such comparison may be made on a pixel-by-pixel basis, limited to excluded pixels (i.e., those outside the mask), in the region of interest as identified by the adaptive ROI segmenter 804.

At 914, the comparison output data 814 is generated, including detected artifacts or differences between the masked input image data 806 and the masked golden sample image 812.

At 916, each detected artifact or difference is provided to the classification model 816, which is configured to assign a class label thereto. The classification model 816 may be a binary classification model.

At 918, classification output data 818 is generated. Classification output data 818 may include the assigned class label.

Because of the identification of the region of interest and consequent masking performed by the adaptive ROI segmenter 804, processing may advantageously be limited only to those parts of the input image 802 (and accordingly of the masked input image data 806 and the masked golden sample image 812) considered relevant by operators and/or the logic of the adaptive ROI segmenter 804. Accordingly, the method 900 may promote greater efficiency and efficacy in computer processing.

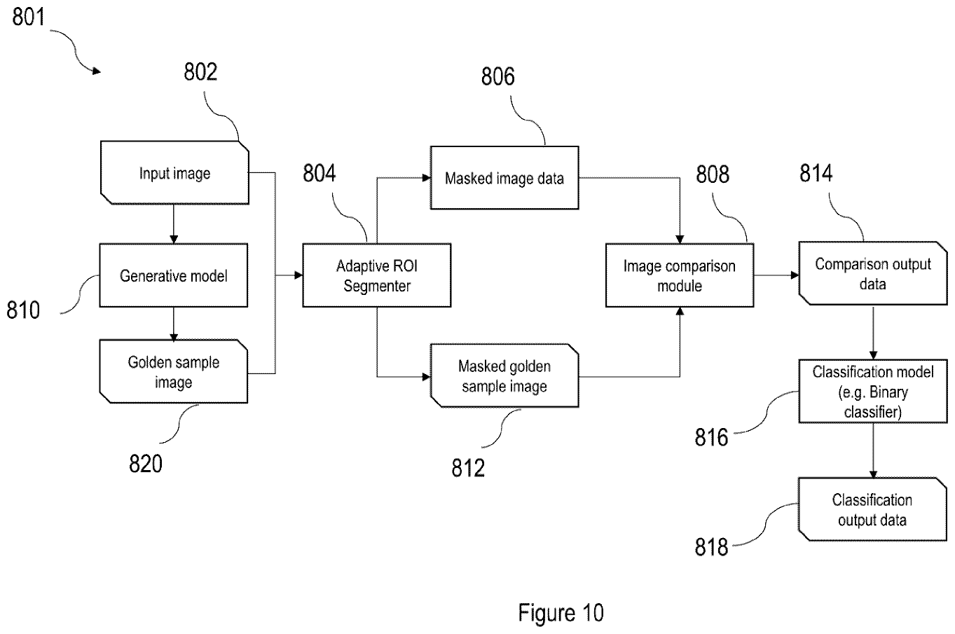

Referring now to FIG. 10, shown therein is a visual inspection pipeline 801 for golden sample image analysis using adaptive ROI segmentation, according to an embodiment. The pipeline 801 is an alternate configuration of the pipeline 800 as shown in FIG. 8. Accordingly, similar reference numbers are used. Only differences will be discussed.

In the pipeline 801, the input image 802 is provided to generative model 810 to produce a golden sample image 820. Accordingly, the golden sample image 820 is generated and then provided to the adaptive ROI segmenter 804 to yield masked golden sample image 812. This process is in contrast to that disclosed with respect to the system 800, wherein the masked golden sample image 812 is generated from the masked image data 806.

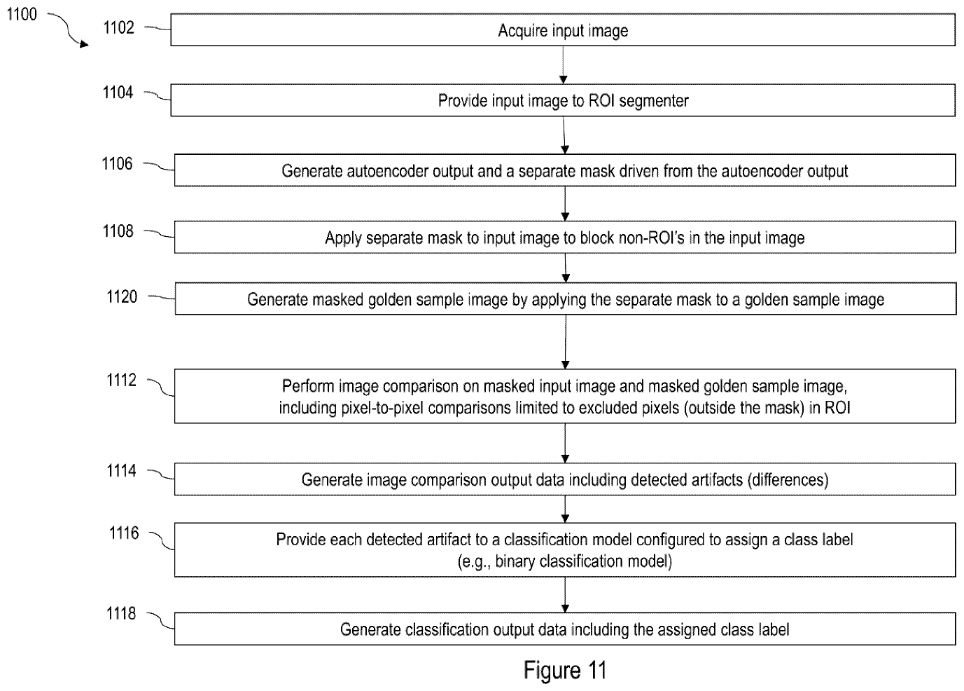

Referring now to FIG. 11, shown therein is a method 1100 according to which the system 801 operates, according to an embodiment. In FIG. 11, steps that are similar to steps in FIG. 9 are denoted by the same last two reference numbers (e.g. 1102, 902). For example, 1102-1108 function similarly to 902-908 of FIG. 9.

In the method 1100, 910 is replaced with 1120. As in the system 801 of FIG. 10, the masked golden sample image 812 is generated by applying the separate mask of the adaptive ROI segmenter 804 to the golden sample image 820. Optionally, the golden sample image 820 is generated from the input image data 802 by the generative model 810.

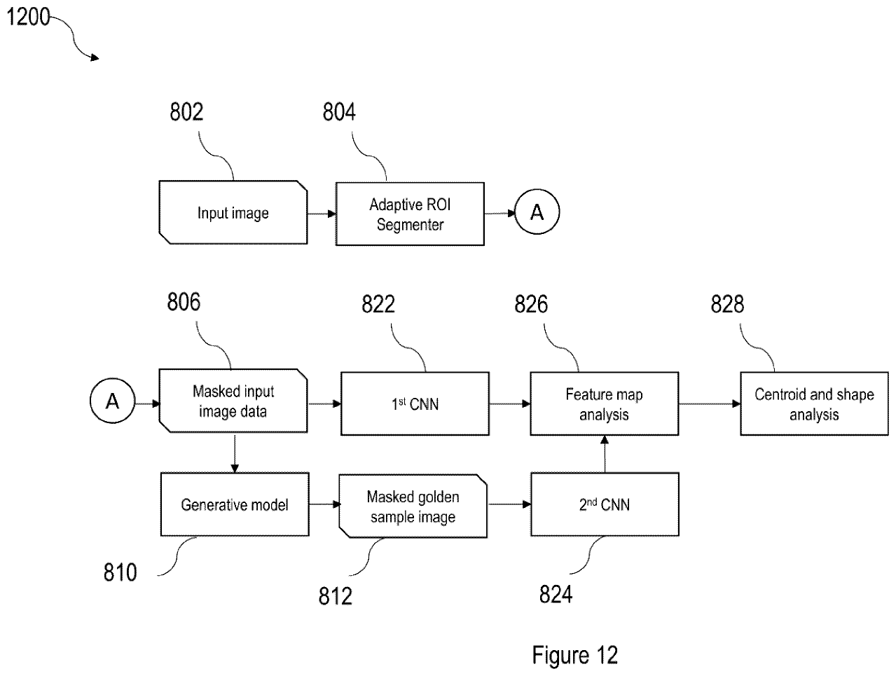

Referring now to FIG. 12, shown therein is a visual inspection processing pipeline 1200 for golden sample image analysis using adaptive ROI segmentation, according to an embodiment.

The pipeline 1200 starts with an input image 802, as in FIG. 8.

The input image 802 is fed to the adaptive ROI segmenter 804. The adaptive ROI segmenter 804 generates masked input image data 806.

The masked input image data 806 is provided as input to a first pretrained convolutional neural network (“CNN”) 822. The first CNN 822 processes the masked input image data 806 and generates a first feature map. The first feature map is provided to a feature map analysis module 826.

The masked input image 806 is also provided to the generative model 810. The generative model 810 generates a masked golden sample image 812. In other embodiments, the input image 802 may be provided directly to the generative model 810 to generate a golden sample image and the golden sample image is provided to the adaptive ROI segmenter 804 to generate the masked golden sample image 812.

The masked golden sample image 812 is provided as input to a second pretrained CNN 824. The second CNN 824 may have the same configurations as the first CNN 822. The second CNN 824 and the first CNN 822 may be separate instances of the same pretrained CNN. In some cases, the second CNN 824 may not be used and the masked golden sample image 812 may be provided to the first CNN 822.

The second CNN 824 processes the masked golden sample image 812 and generates a second feature map. The second feature map is provided to the feature map analysis module 826.

The feature map analysis module 826 performs a feature map comparison of the first and second feature maps and identifies differences (feature map differences). In an embodiment, the feature map comparison uses a down-sampled version of the image and each pixel contains a vector that is compared to a vector of similar size pertaining to the same pixel from the feature map of the input image.

The feature map analysis generates an output including differences (features) identified between the first and second feature maps. Generally, the identified features correspond to a feature or object present in the input image and not in the golden sample image. The feature map analysis 826 may include identification and location of features of the input image 802. Such features may include the presence of defects or certain parts. Such identification and location may include labelling and providing coordinates or bounding boxes with respect to features identified.

Identified features are provided to a centroid and shape analysis module 828 for centroid and shape analysis.

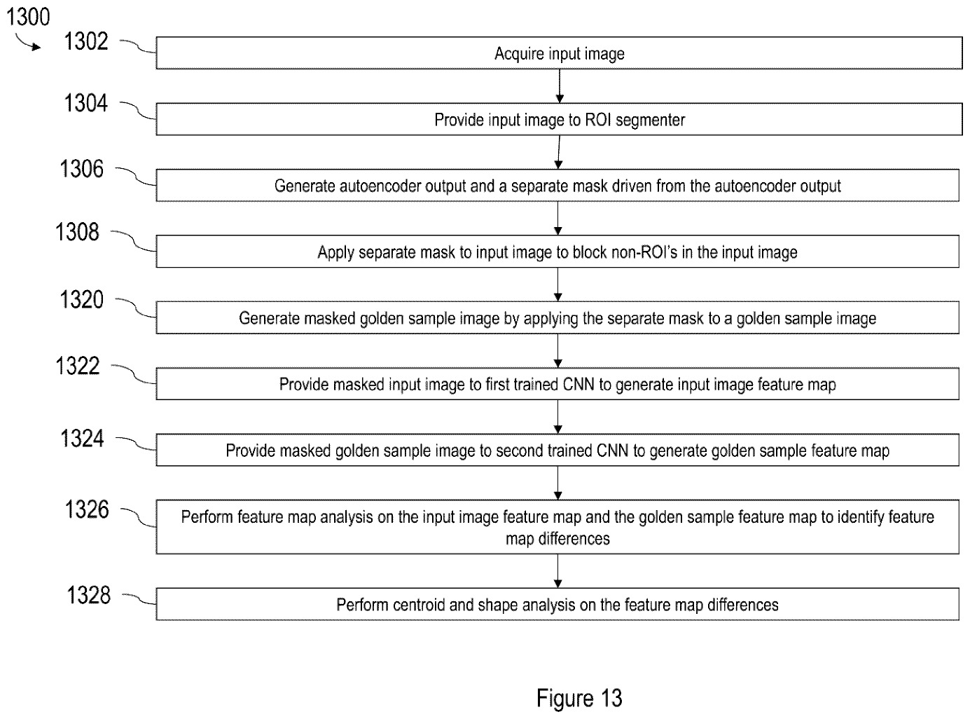

Referring now to FIG. 13, shown therein is a method 1300 according to which the system 1200 operates, according to an embodiment. In FIG. 13, steps that are similar to steps in FIG. 9 are denoted by the same last two reference numbers (e.g. 1302, 902).

Steps 1302 to 1308 function similarly to 902 to 908 of FIG. 9 and the details are not repeated here.

At 1320, a masked golden sample image is generated by applying the separate mask to a golden sample image. This includes using an autoencoder output image to create a second (binary) image. The binary image is then used to mask the original input image. The golden sample image may be a generative golden sample image generated by providing the input image to a generative model trained to generate a golden sample image.

At 1322, the masked input image 806 is provided to the first CNN 822 in order to generate the input image feature map.

At 1324, the masked golden sample image 812 is provided to the second CNN 824 in order to generate the golden sample feature map.

At 1326, feature map analysis is performed on the input image feature map and the golden sample feature map in order to identify feature map differences. This feature map analysis may be in the form of a comparison.

Optionally, at 1328, centroid and shape analysis may be performed on the feature map differences identified at 1326. These processes include a combination of erosion and dilation operators on a binary image.

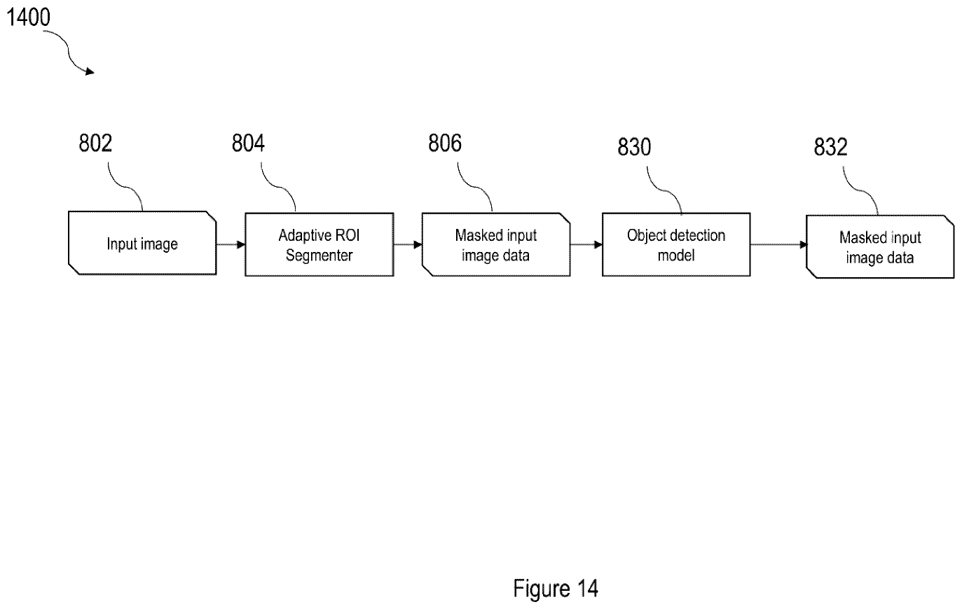

Referring now to FIG. 14, shown therein is a visual inspection processing pipeline 1400 for object detection image analysis using adaptive ROI segmentation according to an embodiment.

The pipeline 1400 starts with an input image 802, as in FIG. 8.

The input image 802 is fed to the adaptive ROI segmenter 804. The adaptive ROI segmenter 804 generates masked input image data 806.

The masked input image data 806 is provided as input to an object detection model 830. The object detection model 830 is configured to perform an object detection task on the masked input image data 806. The object detection model 830 is configured to locate and identify (assign a class label to) objects in an input image. The use of masked input image data 806 as input to the object detection model 830 may advantageously promote more efficient and effective computer processing, as the masked nature of the input image data 806 leaves only the ROI available for processing by the object detection model 830. Accordingly, unnecessary processing and calculations may be avoided.

The object detection model 830 generates object detection output data 832. The object detection output data 832 describes objects detected in the masked input image 806. The object detection output data 832 may include location data (e.g. bounding box) and a class label for each detected object. In a particular embodiment, the detected objects may be defects or certain parts of an article being inspected.

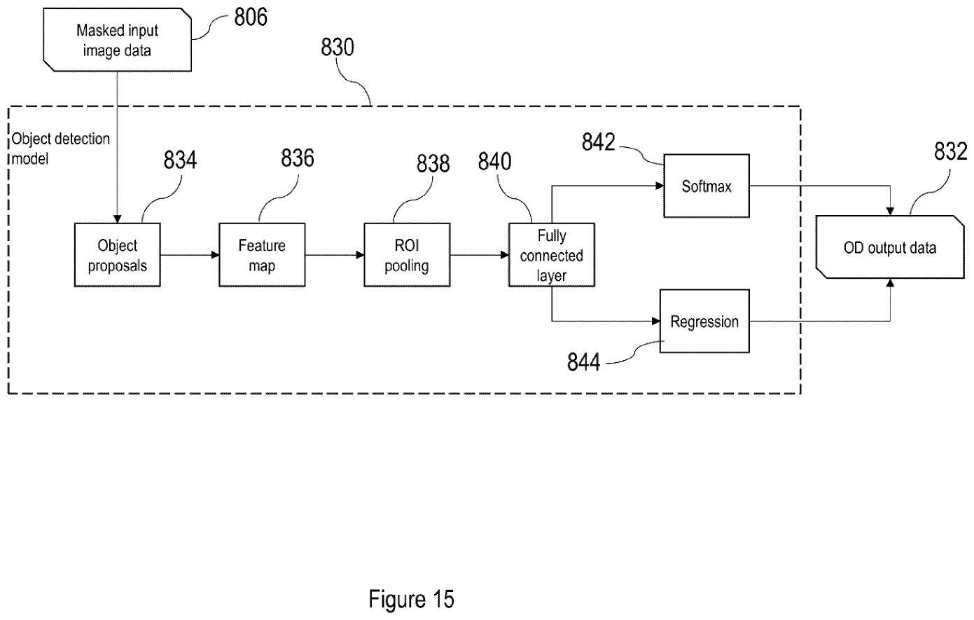

Referring now to FIG. 15, shown therein is the object detection model 830 of FIG. 14 in greater detail, according to an embodiment. The embodiment shown in FIG. 15 includes a CNN architecture.

The object detection model 830 includes a plurality of components or layers. The components include an object proposals component 834, a feature map component 836, a region of interest (RoI) pooling component 838, a fully connected layers component 840, a softmax component 842, and a regressor component 844. The softmax component 842 provides a class label output for each object detected in the image 806. The regressor component 844 provides final bounding box coordinates for each object detected in the image 806. The bounding box coordinates define the target location (i.e. the detected object). The bounding box is a rectangular box which may be determined by the x- and y-axis coordinates in the upper-left corner and the x- and y-axis coordinates in lower-right corner of the rectangle. The class label and final bounding box coordinate outputs may be combined into an object detection output 832 by the object detection model 830. The object detection output 832 may include a confidence score (e.g. between 0 and 1).

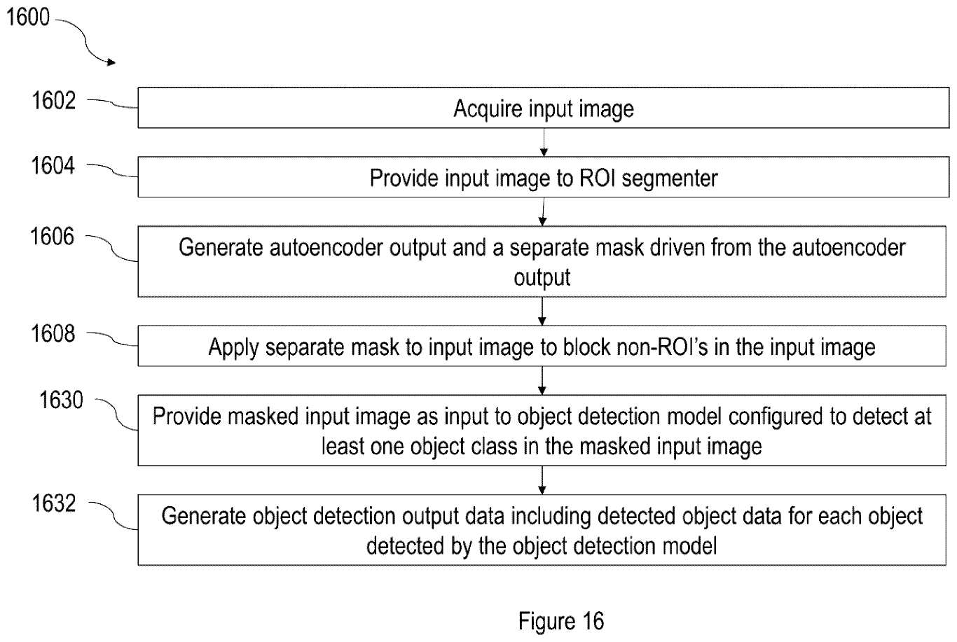

Referring now to FIG. 16, shown therein is a method 1600 of visual inspection using adaptive ROI segmentation in the context of object detection image analysis, according to an embodiment. In FIG. 16, steps 1602 to 1608 function similarly to steps 902 to 908 of FIG. 9 and are not described again here.

At 1630, the masked input image 806 is provided as input to the object detection model 830, which is configured to detect at least one object class in the masked input image 802.

At 1632, the object detection output data is generated, including detected object data for each object detected by the object detection model 830.

While the above description provides examples of one or more apparatus, methods, or systems, it will be appreciated that other apparatus, methods, or systems may be within the scope of the claims as interpreted by one of skill in the art.

1. A system for visual inspection of a target article using adaptive region of interest (“ROI”) segmentation, the system comprising:
a camera for acquiring an inspection image of the target article;
an AI visual inspection computing device for detecting defects or anomalies in the target article, the AI visual inspection computing device comprising:
a communication interface for receiving the inspection image acquired by the camera;
an adaptive ROI segmentation module for processing the inspection image using an ROI segmentation model to generate a masked inspection image in which regions not of interest (“nROIs”) are masked;
an image analysis module for receiving the masked inspection image and analyzing the masked inspection image using an image analysis model to generate output data indicating presence of the defects or anomalies detected by the image analysis model, wherein analysis of the masked inspection image is limited to non-masked ROIs; and
an output interface for displaying the output data.

2. The system of claim 1, wherein the image analysis model comprises an object detection model trained to detect at least one defect class in the masked inspection image.

3. The system of claim 1, wherein the image analysis model comprises a golden sample analysis module configured to compare the masked inspection image to a golden sample image of the target article.

4. The system of claim 1, wherein the image analysis model comprises an object detection model and a golden sample analysis module.

5. The system of claim 4 further comprising a comparison module for comparing object detection output data generated by the object detection model with golden sample output data generated by the golden sample analysis module.

6. The system of claim 3, wherein the golden sample module includes a generative model for generating the golden sample image from the inspection image.

7. The system of claim 2, wherein the output data includes a defect type and a defect location for each defect detected by the object detection model

8. The system of claim 1, wherein the adaptive ROI segmentation model is trained to identify and mask a non-uniform area of the inspection image.

9. The system of claim 8, wherein the non-uniform area comprises any one or more of an improperly illuminated area in the inspection image, a user-defined non-uniform area, a component of the target article that varies across different target articles of the same class, and an irregularly textured area of the target article.

10. The system of claim 2, wherein the output data classifies the target article as either defective or non-defective.

11. A method of visual inspection of a target article using adaptive region of interest (“ROI”) segmentation, the method comprising:
acquiring an inspection image of a target article;
processing the inspection image by masking nROIs in the inspection image using an adaptive ROI segmentation model;
analyzing the masked inspection image using an image analysis model to detect defects or anomalies in the target article;
generating output data based on an output of the image analysis model, the output data indicating presence of the detected defects or anomalies; and
displaying the output data at a user device.

12. The method of claim 11 further comparing object detection output data generated by an object detection model with golden sample output data generated by a golden sample analysis module.

13. The method of claim 11, wherein the output data includes a defect type and a defect location for each defect detected by the object detection model.

14. The method of claim 11, wherein the adaptive ROI segmentation model is trained to identify and mask a non-uniform area of the inspection image.

15. The method of claim 14, wherein the non-uniform area comprises any one or more of an improperly illuminated area in the inspection image, a user-defined non-uniform area, a component of the target article that varies across different target articles of the same class, and an irregularly textured area of the target article.

16. An AI visual inspection computing device for detecting objects in an inspection image using adaptive region of interest (“ROI”) segmentation, the device comprising:
a communication interface for receiving the inspection image acquired by a camera;
an adaptive ROI segmentation module for processing the inspection image using an ROI segmentation model to generate a masked inspection image in which regions not of interest (“nROIs”) are masked;
an image analysis module for receiving the masked inspection image and analyzing the masked inspection image using an image analysis model to generate output data indicating presence of the objects detected by the image analysis model, wherein analysis of the masked inspection image is limited to non-masked regions of interest (“ROIs”); and
an output interface for displaying the output data.

17. The device of claim 16 further comprising a comparison module for comparing object detection output data generated by an object detection model with golden sample output data generated by a golden sample analysis module.

18. The device of claim 16, wherein the output data includes a defect type and a defect location for each defect detected by the object detection model.

19. The device of claim 16, wherein the adaptive ROI segmentation model is trained to identify and mask a non-uniform area of the inspection image.

20. The device of claim 19, wherein the non-uniform area comprises any one or more of an improperly illuminated area in the inspection image, a user-defined non-uniform area, a component of the target article that varies across different target articles of the same class, and an irregularly textured area of the target article.
